(19) United States
(12) Patent Application Publication
(10) Pub. No.: US 2007/0143149 A1
(43) Pub. Date: Jun. 21, 2007

(54) Data tagging and report customization method and apparatus

(76) Inventors: Mark D. Buttner, Middleton, WI (US); Samuel L. Butler, Madison, WI (US); Sumit Rana, Verona, WI (US); Carl D. Dvorak, Verona, WI (US); Daniel J. Donoghue, Oregon, WI (US)

Correspondence Address: QUARLES & BRADY LLP, 411 E. WISCONSIN AVENUE, SUITE 2040, MILWAUKEE, WI, 53202-4497, US

(21) Appl. No.: 11/590,699

(22) Filed: Oct. 31, 2006

Related U.S. Application Data
(60) Provisional application No. 60/731,896, filed on Oct. 31, 2005.

(51) Int. Cl. G06F 19/00

(52) U.S. Cl. 705/3

(57) ABSTRACT

A method and apparatus for use with a database that includes patient charts where each chart includes subsets of patient data, the method for allowing a physician to generate a custom report view (CRV) including at least a subset of the patient data, the method comprising the steps of, during a collection process, providing an interface that enables the physician to access the patient chart data, presenting patient chart data via the interface, receiving a selection from the physician via the interface that selects at least one subset of the chart data and rendering the selected data accessible in a data collector view (DCV) for subsequent use.

### CROSS-REFERENCE TO RELATED APPLICATIONS

This application is based on U.S. Provisional Patent Application Ser. No. 60/731,896 filed on Oct. 31, 2005, and entitled “DATA TAGGING AND REPORT CUSTOMIZATION METHOD AND APPARATUS”.

### STATEMENT REGARDING FEDERALLY SPONSORED RESEARCH OR DEVELOPMENT

Not applicable.

### BACKGROUND OF THE INVENTION

The present invention relates to data collection and organization and more specifically to data collection methods and apparatus that enable a data user to select specific data from a large database and arrange that data in optimal ways.

Hereinafter, the inventions will be described in the context of a medical facility. Nevertheless, it should be appreciated that the inventions herein should be applied in other non-medical industries. In addition, unless indicated otherwise, the term “clinician” will be used to refer to any employee or agent of a medical facility including but not limited to doctors, nurses, clinicians, technicians, other users, etc.

Modern medical facilities generate huge amounts of patient related data (hereinafter “patient data”) and the amount of data generated by such facilities is likely to increase exponentially in the foreseeable future given new procedures, medical equipment (e.g., imaging, test and therapy systems) diagnostic protocols, increasing specialization and increased ability to store vast amounts of data. As in other industries, the medical industry has embraced electronic records, referred to in the industry as electronic medical records (EMRs), to store the onslaught of patient data for subsequent access.

While EMRs have enabled storage of massive amounts of patient data in patient specific charts, huge patient data charts have, in at least some ways, complicated the tasks associated with delivering quality medical services. For example, each clinician that performs a patient associated medical function while a patient is at a facility typically needs access to only a small subset of patient chart data rather than the patient's entire EMR. For instance, a cardiologist treating an inpatient may only be concerned with data relevant to provision of cardiopulmonary care and likely would not have an interest in analyzing sexual dysfunction, renal, neurological, or other types of data not relevant to cardiopulmonary care. In fact, in most cases, cardiologists strongly prefer not to have data that is not needed for performing their specific tasks interspersed with data relevant to provision of cardiopulmonary care. This problem extends to all clinical practices, especially specialties. While software search tools have been developed to help manage EMTs and for accessing data within a patient chart, using the tools to ferret through a large patient chart is laborious and time consuming.

As another example, as a clinician is examining a patient or subsequent thereto as the clinician is analyzing patient data in a chart to develop an opinion, as the clinician is examining a complete patient chart, in an exemplary case a clinician may focus on fifteen or more specific and different subsets of data (e.g., images, test results, current conditions, data trends over time, current and past medications and treatment records, family medical history, etc.) that together help the clinician formulate her opinion. In this case, while the clinician may have thought that each of the fifteen data subsets was important when viewed, the clinician may not remember all of the data subsets when subsequently generating a report. Here, where a clinician's memory fails, a record is often incomplete.

As one other example, during and/or after a visit with a patient, clinicians are often required to generate a report that is added to a patient's chart which summarizes the clinician's thoughts, observations, diagnosis and prescription. In short, the patient visit report is intended to tell a story about the visit and why and how the clinician reached specific conclusions regarding the patient. In many cases, in order to memorialize a clinician's thought process and to justify a diagnosis and prescription, clinicians desire or, in some cases, are required by facilities, insurance companies, governmental agencies, other regulatory entities, etc., to reference or include specific patient chart information in patient reports. For instance, where a clinician examines a most recent set of fifty magnetic resonance (MR) images that are stored in a patient's chart when diagnosing a specific medical condition, in the report the clinician may specifically reference three of the MR images from the set that were critical in the clinician's decision making process. As another instance, a clinician may reference specific test results or an observed test result trend over a prolonged period of time to support a specific diagnosis and prescription. In theory, these cases where specific patient chart information is referenced in a patient record, when the record is subsequently reviewed by the clinician that generated the record or by another clinician, the reviewing clinician can determine the record generating clinician's thought process by analyzing the information in the report itself as well as by accessing the chart data that is referenced in the report.

In practice, unfortunately, referencing specific chart information in a report is not very easy. To this end, in many cases there is no standard way to refer in a report to a specific sub-set of data in a chart. For instance, one clinician may refer to a set of CT images as “the most recent set of images” while a second clinician refers to a set of CT images as “the CT images” and a third clinician refers to the set as “CT image set obtained during 10:30 appointment on 9-3-05”. In fact, in most cases where a specific way of identifying CT images in reports is not enforced by a facility, even a single clinician may routinely employ different types of CT image labels where some are more descriptive than others. This type of cryptic labeling makes it difficult at best for a subsequent clinician that examines the report to identify and access specific chart information used by the report generating clinician in their decision making process. In addition, cryptic labeling can result in subsequent mistakes. For instance, where a report references “the most recent set of images”, if intervening images are added to a patient's chart and another clinician subsequently reviews the report, the reviewing clinician could easily make the mistake of assuming that the intervening images were the ones referenced in the report. Many other mistakes are possible.

As yet another example, in many cases, a first clinician that specializes in one type of medicine (e.g., a cardiologist) may prefer reports that have a first very specific format and that almost always include a specific subset of the data in a patient's chart while a second specialist may prefer reports that have a second very specific format and that almost always include a second specific subset of the data in a patient's chart. In fact, even in the case of a single specialty, different clinicians may prefer different subsets of data and/or different data formats in a chart or a report.

### BRIEF SUMMARY OF THE INVENTION

It has been recognized that software tools can be provided that enable clinicians to tag information in massive patient charts that is considered interesting from the clinician's perspective and that the clinician wants or may want to reference or render subsequently within a custom report view (CRV) for a specific patient. Thereafter, when the clinician generates the CRV, in at least some embodiments, the clinician may initially be presented with a CRV type template that includes the tagged information laid out in a specific format. Here, the CRV template operates to, instead of providing a patient specific chart, present a patient/disease or condition or clinician preferences type chart based on clinician preferences or diagnosis, gender, age, treatment plan, etc.

In addition, in at least some cases it is contemplated that the system may be programmed to intelligently identify and suggest different types of data collector views (DCVs) or CRVs given specific patient or circumstantial characteristics. For instance, when a clinician views an EMR associated with a patient that does not already have a DCV associated with the patient, the system may be programmed to glean information from the EMR such as gender, age, disease, etc., and search for a previously defined or used DCV associated with a different patient having similar characteristics and then to either suggest the DCV to the clinician or automatically instantiate an instance of the DCV and populate the instance with information from the EMR. A clinician can add additional information to the CRV to further customize a CRV for a specific patient. Here, the idea is not simply to generate another instance of data that is available in other areas of a patient's chart but rather to conglomerate all data relevant to a visit and a clinician's thought process in a single CRV such that a CRV user needn't access other chart data while reviewing the CRV, to explain why the data in the CRV is relevant and thereby to memorialize and/or justify and/or explain a clinician's ultimate medical decisions.

In other embodiments a data collector view (DCV) corresponding to chart data previously selected by a clinician as potentially to be included in a CRV may be provided to a clinician during a CRV generating process where the clinician can select any of the data in the DCV to immediately access the data for inclusion in a CRV. For instance, where three MR images from a set of 50 are selected by a clinician during a data collection process as critical to the clinician's thought process, each of the three images may be referenced in (e.g., a selectable link may be provided in) or copied to a DCV. In this case, during a CRV specifying process, the DCV may be presented to the clinician so that data can be selected for inclusion in a final CRV.

In at least some embodiments a clinician may be able to customize CRV templates so that CRV generating software automatically accesses a patient's chart prior to when a clinician begins to review an EMR, identifies data or data of the same type required by the CRV template and then generates an instance of the CRV template for the clinician. Here it is contemplated that the clinician will be able to alter the CRV at will so that CRV format can be modified and/or so that different chart data subsets can be automatically accessed and used to populate at least certain fields within the CRV.

Consistent with the above, at least some embodiments include a method for use with a database that includes patient charts where each chart includes a plurality of subsets of patient data, the method for allowing a clinician to generate a custom report view (CRV) including at least a subset of the patient data, the method comprising the steps of during a collection process, providing an interface that enables the clinician to access the patient chart data, presenting patient chart data via the interface and receiving a selection from the clinician via the interface that selects at least one subset of the chart data and rendering the at least one subset of the data chart data accessible in a data collector view (DCV) for subsequent use.

In addition, some embodiments include a method for use with a database that includes patient charts where each chart includes subsets of different types of patient data, the method for allowing a clinician to generate a custom report view (CRV) including subsets of patient data from a chart, the method comprising the steps of providing an interface, receiving specifying information from the clinician via the interface that specifies a subset of chart data types to be includes in a data collector view (DCV) template and storing the specified subset of chart data types in as a DCV template for subsequent use.

Moreover, some embodiments include a method for use with a database that includes patient charts where each chart includes subsets of different types of patient data, the method for allowing a clinician to generate a CRV including subsets of patient data from the chart, the method comprising the steps of providing an interface, receiving specifying information from the clinician via the interface that specifies a subset of chart data types and formatting information and storing the chart data types and formatting information as a CRV template in a database for subsequent use.

Moreover, some embodiments include a method for use with a database that includes patient charts where each chart includes subsets of patient data, the method for allowing a clinician to form a data DCV that includes chart data subsets, the method comprising the steps of during a data collection process, providing an interface that enables the clinician to access chart data for a first patient, presenting first patient chart data via the interface, receiving indications from the clinician via the interface that select a plurality of the subsets of the chart data and during a CRV specifying process, presenting a CRV and the plurality of subsets of chart data to the clinician.

Furthermore, some embodiments include a method for use with a database that includes patient charts where each chart includes subsets of patient data, the method for allowing a clinician to form a data collector view (DCV) that includes chart data subsets, the method comprising the steps of during a data collection process, providing an interface that enables the clinician to access chart data for a first patient, presenting first patient chart data via the interface, receiving indications from the clinician via the interface that select a plurality of the subsets of the chart data, rendering the selected plurality of subsets of chart data accessible via a DCV and identifying other data subsets that are associated with the data subsets rendered accessible.

In addition, other embodiments include a method for use with at least first and second different software programs where each program presents data subsets when operating, the method for collecting data subsets and comprising the steps of, providing an interface, performing the first program to provide data subsets via the interface, receiving selections from an interface user selecting at least a first data subset provided by the first program, rendering the first data subset accessible via a DCV, performing the second program to provide data subsets via the interface, receiving selections from an interface user selecting at least a first data subset provided by the second program and rendering the data subset selected from the second program accessible via the data collector.

Other embodiments include an apparatus for use with a database that includes patient charts where each chart includes a plurality of subsets of patient data, the system for allowing a clinician to generate a custom report view (CRV) including at least a subset of the patient data, the system comprising an interface that enables the clinician to access the patient chart data during a collection process, the interface including an input for receiving a selection from the clinician via the interface that selects at least one subset of the chart data and a processor for rendering the at least one subset of the data chart data accessible in a data collector view (DCV) for subsequent use.

Still other embodiments include an apparatus for use with a database that includes patient charts where each chart includes a plurality of subsets of patient data, the system for allowing a clinician to generate a custom report view (CRV) including at least a subset of the patient data, the system comprising a means for enabling the clinician to access the patient chart data during a collection process, the interface including an input for receiving a selection from the clinician via the interface that selects at least one subset of the chart data and means for rendering the at least one subset of the data chart data accessible in a DCV for subsequent use.

Other embodiments include a method for use with a database that includes patient charts where each chart includes subsets of patient data where at least one of the DCVs and CRVs can be formed that include chart data subsets, the method for automatically identifying trends in at least one of DCVs and CRVs and generating at least one of DCV templates and CRV templates for subsequent use, the method comprising the steps of, during a data collection process: providing an interface that enables the clinician to access chart data for a first patient, presenting first patient chart data via the interface, receiving indications from the clinician via the interface that select a plurality of the subsets of the chart data for inclusion in at least one of a DCV and a CRV, rendering the selected plurality of subsets of chart data accessible via a DCV, identifying a circumstance set that exists when the at least one of the DCV and the CRV is indicated, identifying trends in the at least one of the indicated DCVs and the CRVs and associated circumstance sets and, when a trend is identified, storing the circumstance set along with the associated one of the DCV template and the CRV template for subsequent use.

In at least some cases the method further includes the steps of, subsequent to storing the at least one of a DCV template and a CRV template, while a clinician accesses chart data for at least one of the first patient and a second patient, monitoring use of the interface to identify circumstance sets that occur, comparing occurring circumstance sets to the stored circumstance sets, when an occurring circumstance set matches a stored circumstance set, accessing the at least one of the DCV template and the CRV template associated with the stored circumstance set, accessing information required to instantiate an instance of the at least one of the accessed DCV template and the CRV template from the chart data accessed by the clinician and instantiating an instance of the at least one of the accessed DCV template and the accessed CRV template using the accessed information.

Still other embodiments include a method for use with a database that includes patient charts where each chart includes subsets of patient data where at least one of DCVs and CRVs can be formed that include chart data subsets, the method for automatically instantiating an instance of at least one of a DCV and a CRV when certain circumstances occur, the method comprising the steps of storing at least one DCV template and a CRV template, the DCV template specifying specific data items required to instantiate a DCV instance that is consistent with the DCV template, the CRV template specifying specific data items required to instantiate a CRV instance that is consistent with the CRV template, storing a circumstance set that is associated with the stored one of the DCV and the CRV template, providing an interface that enables the clinician to access chart data for a first patient, accessing the first patient chart using the interface, identifying at least one occurring circumstance set including circumstances related to the use of the interface and the information in the first patient chart, comparing occurring circumstance sets to the stored circumstance sets, when an occurring circumstance set matches a stored circumstance set accessing the template associated with the stored circumstance set, accessing information required to instantiate an instance of the accessed template from the chart data accessed by the clinician and instantiating an instance of the accessed template using the accessed information.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic diagram illustrating an exemplary system used to implement the present invention;

FIG. 2 is a schematic of a screen shot consistent with at least some inventive aspects of the present invention;

FIG. 3 is a flow chart illustrating a method whereby a clinician generates a data collector according to at least one aspect of the present invention;

FIG. 4 is a screen shot similar to the screen shot of FIG. 2, albeit illustrating data selection activities for identifying data to be copied into a data collector according to at least some inventive aspects;

FIG. 5 is similar to FIG. 2, albeit illustrating other aspects of an inventive data collection methodology;

FIG. 6 is similar to FIG. 2, albeit illustrating a data collector window shown over a patient chart screen shot;

FIG. 7 is a flowchart illustrating a method whereby a clinician uses data collector information to enhance a reporuprogress note;

FIG. 8 is similar to FIG. 2, albeit illustrating the process of copying data from a data collector field to a reporuprogress note;

FIG. 9 is a flowchart illustrating a submethod that may be used to supplement the method of FIG. 3 for storing a new data collector template type;

FIG. 10 is a schematic illustrating a data collector template type database according to at least some inventive embodiments;

FIG. 11 is a flowchart illustrating a submethod that may be used to supplement the method of FIG. 3 for using a pre-stored collector template to generate a data collector;

FIG. 12 is similar to FIG. 2, albeit illustrating selection of a collector template type;

FIG. 13 is a flowchart illustrating data collector supplementation with latest data;

FIG. 14 is a flowchart illustrating a submethod that may be added to the method of FIG. 11 enabling a clinician to store a new report template type;

FIG. 15 is a schematic illustrating a report template type database that is consistent with at least some inventive embodiments;

FIG. 16 is similar to FIG. 2, albeit illustrating a data collector window where at least one of the fields includes initially selected data and latest data of the same type;

FIG. 17 is a flowchart illustrating a submethod that may be included in the method of FIG. 7 whereby a clinician can use a predefined and stored template type to generate a record/progress note;

FIG. 18 is a flowchart illustrating a submethod that may be included in the method of FIG. 3 for providing notice to a clinician that data required to instantiate an instance of a data collector is missing from a patient's chart;

FIG. 19 is a schematic illustrating a window that may be opened to suggest data to be copies to a collector;

FIG. 20 is a flow chart illustrating an automated template forming method; and

FIG. 21 is a flow chart illustrating an automated DCV instantiation method.

### DETAILED DESCRIPTION OF THE INVENTION

Hereinafter, as in the Background Of The Invention section above, the label “clinician” will be used generally to refer to any employee of a medical facility that has the authority to access customer or patient records including, but not limited to, doctors, nurses, orderlies, facility administrators, technicians, schedulers, support staff, etc. In addition, although the inventive features may be used with various types of software tools and in many different industries, the invention will be described in the context of an exemplary medical facility and more specifically a chart reviewing and documentation generating software program used at the facility. Moreover, while the inventions will be useful by many different clinicians and to view charts and generate documentation associated with many facility patients, to simplify this explanation, here, the inventions will be described in the context of a single clinician, Dr. Culligan Whyte and a single patient, Ms. Rosa Garcia, unless indicated otherwise.

Furthermore, in at least some embodiments, herein it will be assumed that patient data charts are stored as subsets of information of specific types where a subset of information in a specific patient chart can be accessed by referring to the data type. For instance, one hematology data type may be uniquely referencable as “Test Data-Neutrophils” while another type is uniquely referencable as “Test Data-Lymph %”.

In addition, while the invention can be used to streamline the process of generating any type of documentation (e.g., notes, reports, etc.), in the explanation to follow the phrase “custom report view” (CRV) will be used to refer generally to generated documentation of any type that is generated by a clinician regarding a patient including but not limited to progress notes, admit notes, discharge notes, records of any type, reports, etc.

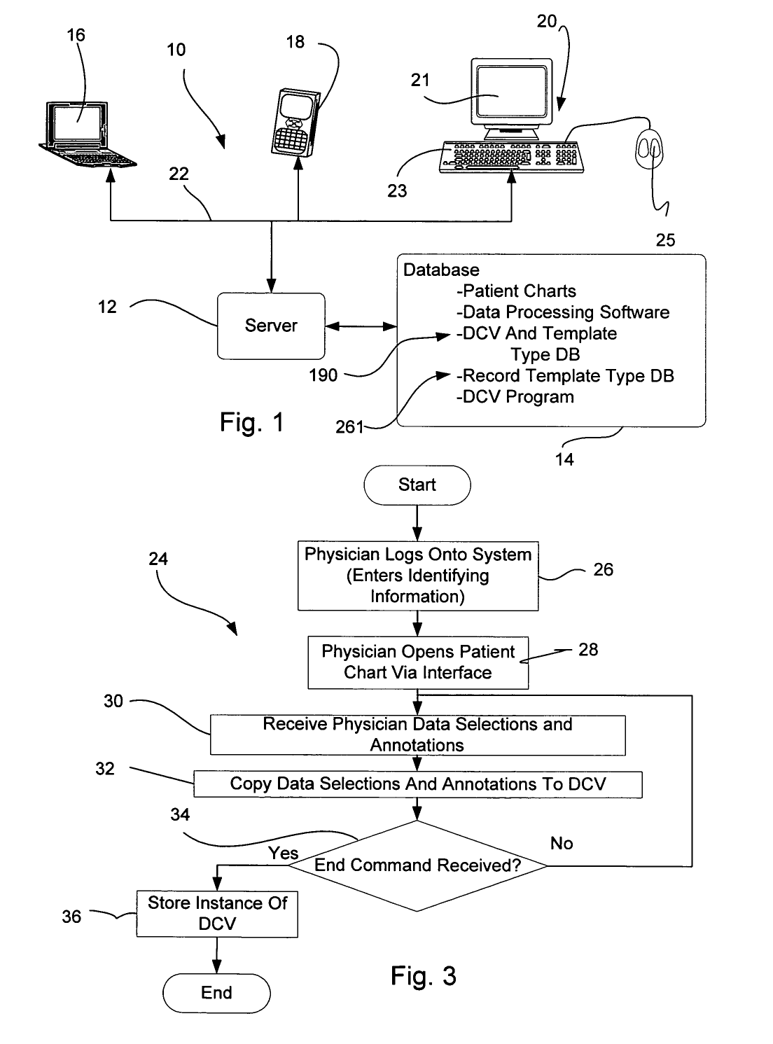

Referring now to the drawings wherein like reference numbers correspond to similar elements throughout the several views and, more specifically, referring to FIG. 1, the present invention will be described in the context of an exemplary computer information system 10 including, among other components, a server 12, a database 14, a plurality of interface devices including an exemplary laptop computer 16, a handheld computing device 18, a work station 20 and a network 22 that may be either a hardwired network or a wireless network or a combination of hardwired and wireless networks. Server 12 is a conventional server capable of running various types of computer software programs to perform various data management processing and data manipulation functions. Server 12 is linked to database 14 for two-way communication therewith to obtain information therefrom and to provide information thereto for storage. Exemplary and simplified database 14 stores, among other information, patient data charts, data processing software run by server 12 and some version of a DCV program. In addition, in at least some embodiments, database 14 stores a DCV and DCV template type database 190 and a CRV template type database 261 that are useful to facilitate at least some aspects of some inventive embodiments.

Referring still to FIG. 1, in addition to being linked to database 14, server 12 is linked to each of the interface devices 16, 18 and 20 via network 22. While devices 16, 18 and 20 have different forms, each device has several features that are generally common and necessary for purposes of the present invention and therefore, to simplify the present explanation, only device 20 will be described here in any detail. In addition, hereafter, unless indicated otherwise, while any of devices 16, 18 or 20 could be used to facilitate inventive methods, the methods will be described in the context of interface 20. In at least some embodiments, interface device 20 includes an input component such as a keyboard 23, a mouse-type device 25 for controlling a display screen cursor, etc., and a display 21 for presenting information to a clinician using interface 20. Other types of input and output devices are contemplated, and the invention should not be limited to the exemplary devices described above.

Referring yet again to FIG. 1, during operation, server 12 runs the data processing software stored in database 14 to perform various functions. One of the functions performed by server 12 pursuant to the present invention is to enable a clinician to access and examine detailed information charts corresponding to specific facility patients. To this end, server 12 runs the software to access patient information and then provides that information to the clinician via intuitive and user friendly graphical user interface (GUI) software that presents screen shots via display 21.

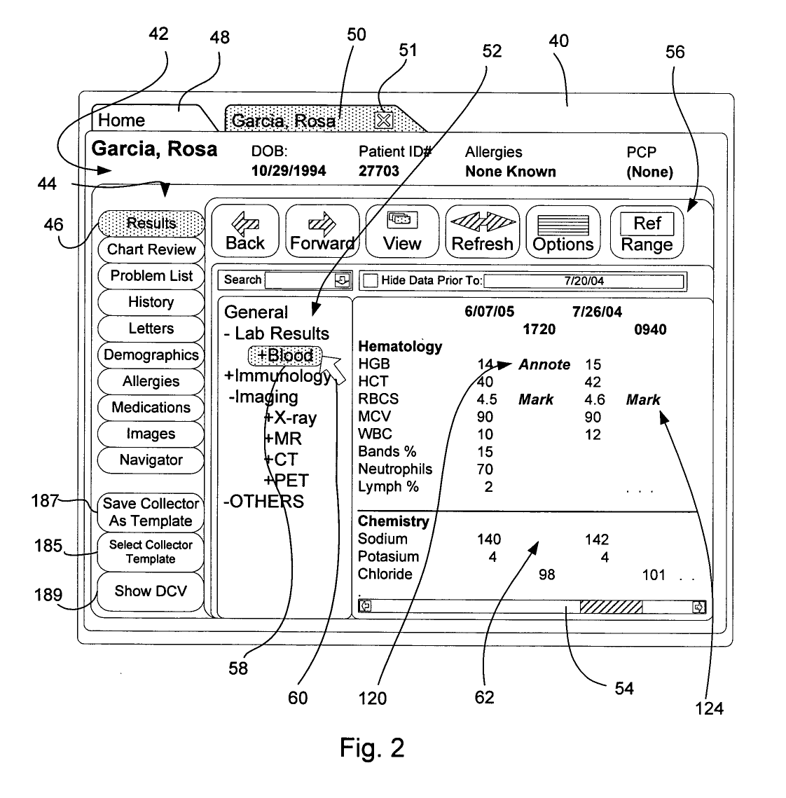

Referring still to FIG. 1 and now also to FIG. 2, an exemplary patient chart screen shot 40 that may be provided to a clinician via display 21 is illustrated in FIG. 2. Screen shot 40 includes a plurality of different fields in which textual information is provided as well as on-screen selectable icons that can be selected via movement of an on-screen pointer icon 60 and a clinician selection activity associated therewith. For example, as well known in the computing industry, mouse 25 may be used to move pointer icon 60 about on display screen 21 and single or double clicks of mouse buttons (not labeled) can be used to select on-screen selectable icons (e.g., BACK or FORWARD icons in navigation field 56). Screen shot 40 includes, among other information, a general patient data field 42, navigation icons that are arranged to form a navigation tool bar in a navigation field 56 as well as navigation tabs 48 and 50, a single row of data selection icons 44, three data collector icons 187, 185 and 189 that appear below selection icon row 44, a directory field 52 and a data display field 62. Field 42 provides general information associated with a specific facility patient for which data is provided in display field 62. To this end, in FIG. 2, the exemplary patient specific information indicates that the data in field 62 is associated with Ms. Rosa Garcia and provides the patient's date of birth, a patient ID number, general allergies information and so on. In at least some applications it is contemplated that the general information fields may be customized to display any subset of stored information associated with a patient.

Referring still to FIG. 2, HOME icon 48 can be selected to access a general data chart home page to segway to another patient's data chart. Icon 50 is selectable to access Ms. Garcia's data chart as shown in FIG. 2. Although not illustrated in FIG. 2, other patient charts could be opened in the “background” of Ms. Garcia's and would be represented by tab icons similar to icon 50 along the top edge of screenshot 40. Ms. Garcia's chart can be closed by selecting close icon 51.

The icons in navigation field 56 include standard icons used in web type software programs for navigating through data. For example, in addition to other screen selectable icons, field 56 includes a BACK icon, a FORWARD icon and a VIEW icon for stepping back to previously displayed data, forward to previously displayed data and modifying the view of the data provided, respectively.

Referring yet again to FIG. 2, data selection icon row 44 includes a plurality of screen selectable icons that enable a clinician to view different subsets of data associated with a specific patient. For example, row 44 includes a RESULTS icon 46, a CHART REVIEWING icon, a PROBLEM LIST icon, a HISTORY icon, etc. When one of the icons in row 44 is selected, a directory of sub-information categories associated with the icon selected from row 44 is provided in directory field 52. For example, as illustrated in FIG. 2, when RESULTS icon 46 is selected, test result categories are provided in list form in directory field 52. The exemplary list in FIG. 2 includes a “Lab Results” entry, an “Immunology” entry, and an “Imaging” entry. In FIG. 2, each of the lab results and imaging entries have been expanded so that sub-entries associated therewith are shown. In particular, a “Blood” entry 58 is shown under the lab results entry. Where a different icon is selected from row 44, a different directory of sub-information categories is provided in list form in directory field 52. In the illustrated embodiment, each of the entries in field 52 comprises hyperlink text that is selectable via pointer icon 60. When one of the hyperlink text entries in field 52 is selected, the entry is highlighted and information associated therewith is provided in data display field 62. In the illustrated example, the “Blood” entry is shown highlighted (see 58) to indicate that the entry has been selected and information associated therewith is provided in field 62.

Referring once again to FIG. 2, the exemplary information in field 62 includes separate hematology and chemistry subsets associated with tests that took place on specific dates and at specific times. In addition to displaying data, field 62 includes a sliding bar icon 54 that can be used to access different subsets of data when all of the data associated with a selected and highlighted field 52 cannot be displayed in field 62 at one time.

Referring still to FIG. 2, in addition to including icons that enable a clinician to view different chart data subsets, row 44 includes a NAVIGATOR icon at the bottom which, in at least some applications, is useable to segway to report/progress note generating software tools that will be described below. Other interface tools for navigation are contemplated. Below row 46, screenshot 40 includes data collector icons 187, 185 and 189 which are described in greater detail below.

Referring once again to FIG. 2, while only a small amount of data is shown in field 62, it should be appreciated that the chart associated with each facility patient often includes a huge amount of data accumulated during tens and even hundreds of different visits to a facility and/or to other medical facilities and over the course of many years. In most cases, when a clinician reviews patient chart data, only a small percentage of the total data that comprises the chart will be of interest to the clinician when evaluating the patient's condition or prescribing a treatment routine. According to at least some inventive embodiments, a DCV program (see again the DCV program in database 14 of FIG. 1) is provided that allows a clinician to select specific data from within a patient's chart to form a customized and dynamic subset of relevant data for subsequent use. To this end, an exemplary method 24 is illustrated in FIG. 3 that enables a clinician to create a DCV that includes a customized and dynamic subset of patient chart information for subsequent use.

Referring now to FIGS. 1 and 3, at block 26, a clinician logs onto system 10 via interface 20 by entering clinician specific identifying information (e.g., user name and password). At block 28, the clinician opens the patient chart via interface 20. Here, referring again to FIG. 2, it is assumed that Dr. Culligan Whyte has logged onto system 10 and has accessed Rosa Garcia's blood related lab results by selecting the RESULTS and BLOOD icons that are shown highlighted (see 46 and 58, respectively).

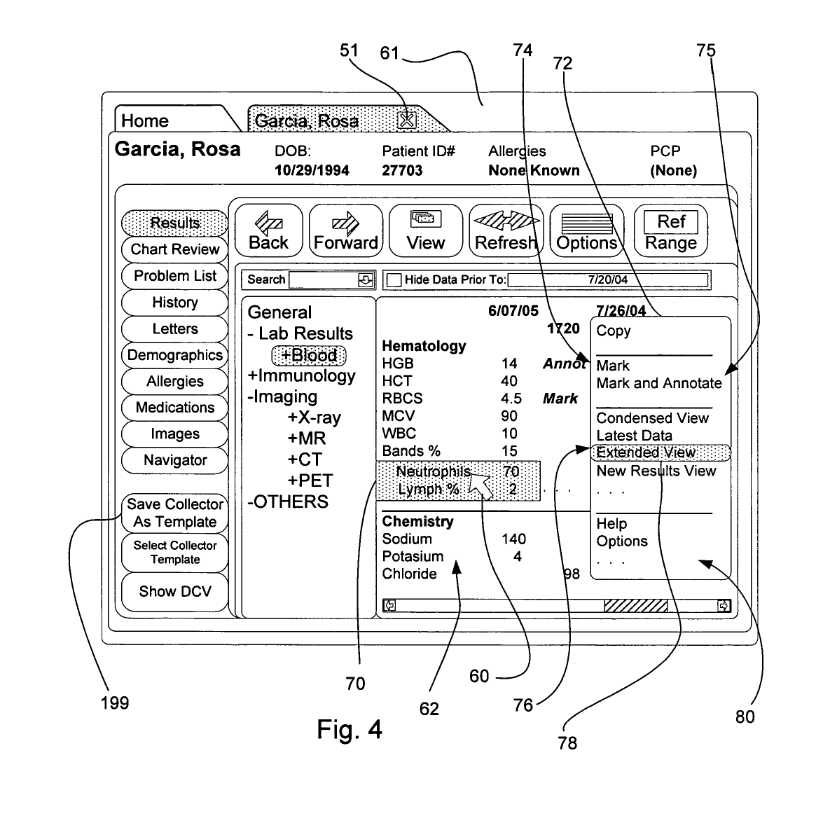

Referring still to FIGS. 1, 2 and 3, at block 30, the clinician selects a subset of the data displayed via data display field 62. To this end, referring also to FIG. 4, an exemplary selection of the hematology data corresponding to Neutrophils and Lymph % generated on Jul. 7, 2005 at 5:20 p.m. (e.g., time 1720) is shown as having been selected via pointer icon 60 and hence is highlighted (see 70).

When a subset of field 62 data is selected, in at least some inventive embodiments, a menu window 72 is opened that may include selectable hyperlink text entries for performing different functions. Here, it should be appreciated that any of several different types of linking or referencing tools akin to hyperlink text may be included as part of the interface and that the inventions are described in the context of hyperlink technology specifically in the interest of simplifying this explanation. The functions in menu window 72 include, among others, a “Mark” entry 74, a “Mark and Annotate” entry 75 and a plurality of view entries collectively identified by numeral 76. As the label implies, “Mark” entry 74 can be selected to indicate that the data most recently selected or specified by the clinician (see highlight 70 in FIG. 4) should be marked and hence included in a DCV. The “Mark and Annotate” entry 75 is selectable to indicate that the highlighted data should be included in a DCV and to allow the clinician to enter and attach a comment to the highlighted data where the comment is also included in the DCV.

Referring still to FIG. 4, view entries 76 include several hyperlink text entries that are selectable to specify how data that is copied to or referenced within a DCV should appear in the DCV and whether or not updated or new data like the selected and copied or referenced data should be included in the DCV. In this regard, when data is copied to or referenced in a DCV, in at least some cases, because a clinician will want to memorialize the data to support the clinician's assessment of a patient's condition at the time the data is copied or referenced, the clinician will want the data stored in the DCV to include the originally copied data. In addition, in at least some cases, a clinician may subsequently also want notice when more current data of the type originally copied to the DCV is available. For instance, in the case of the FIG. 4 hematology data for Ms. Garcia, if new tests are performed on Jul. 21, 2005 (e.g., 2 weeks after the originally copied data was generated), Dr. Whyte may want notice of the new results as well as data indicating the result. Similarly, if new tests were conducted several times since the original hematology data was copied to the collector, Dr. Whyte may want notice and data associated with all the test results so that Dr. Whyte can identify symptom progression. View entries 76 allow a clinician to select data updates to be included in a DCV.

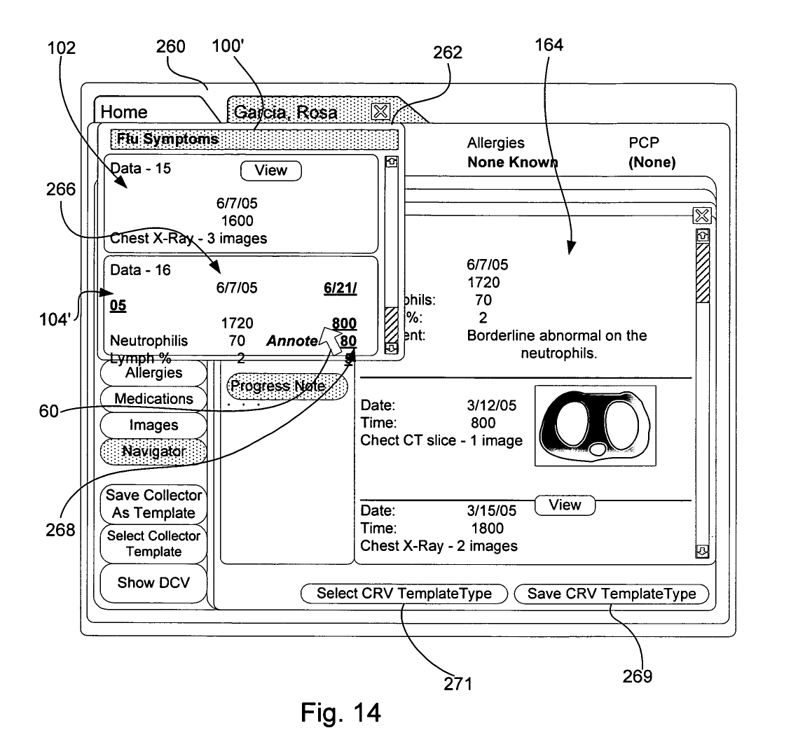

Entries 76 allow a clinician to specify, on a DCV data sub-set by sub-set basis, whether or not the DCV should show original data, only the latest data, original and all subsequent data or original and new data. To specify that a collector should only show original data, a “Condensed View” entry is selectable. To specify that only the latest data should be shown, a “Latest Data” entry is selectable. To specify that original and all subsequent data (i.e., if five subsequent similar tests have been performed, the original data and data from all five subsequent tests is to be presented) should be shown in a collector, an “Extended View” entry is selectable. To specify that original and the latest data should be shown, a “New Results View” entry is selectable. In FIG. 4, the “Extended View” entry is shown as selected (see highlight 78). In FIG. 14, a DCV window 100′ shows an example of extended view data including originally selected data 266 and subsequent data 268 of the same type.

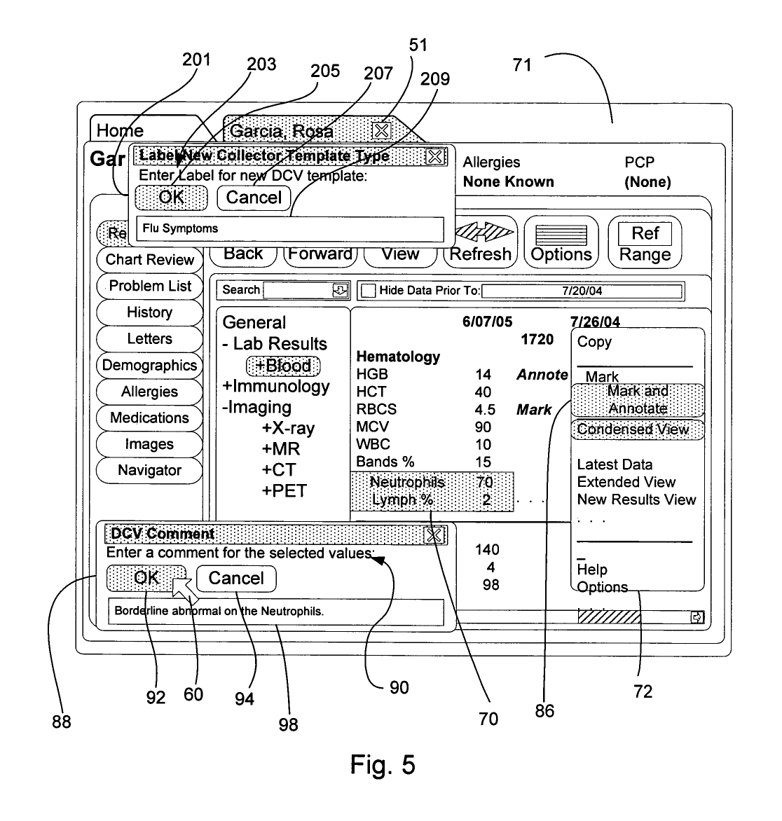

Referring once again to FIG. 1 and now also to FIG. 5, FIG. 5 includes a screen shot 71 similar to the shot 61 of FIG. 4. In at least some embodiments, when “Mark and Annotate” entry is selected, the entry is highlighted as indicated at 86 and a DCV comment window 88 is opened. Exemplary window 88 includes instructions 90 instructing a clinician to enter a comment for the selected values and includes a text entry field 98 for receiving a text comment from the clinician. In addition, window 88 includes an OK icon 92 and a CANCEL icon 94. After a comment has been entered in field 98, icon 92 can be selected via pointer icon 60 to enter the clinician's comment along with the highlighted data (see again highlight 70 in FIG. 5). To cancel the comment, the clinician can simply select CANCEL icon 94.

Referring still to FIGS. 1 and 5 and again to FIG. 3, after a clinician enters a comment in field 98 and selects OK icon 92, control passes to block 32 where the selected data and comment are copied to or referenced in a DCV. At decision block 34, server 12 determines whether or not the clinician has indicated that his review of the patient's chart data has been completed. Here, completion may be indicated by selecting the NAVIGATOR icon at the bottom of row 44 (see FIG. 4), selecting the close icon 51 at the top of the screen shot, etc. Where review of the chart data is not complete, control passes back to block 30 where server 12 continues to monitor for additional data selections and comments by the clinician. Where data review is complete and the clinician indicates so, control passes to block 36 where the specified DCV is stored for subsequent use.

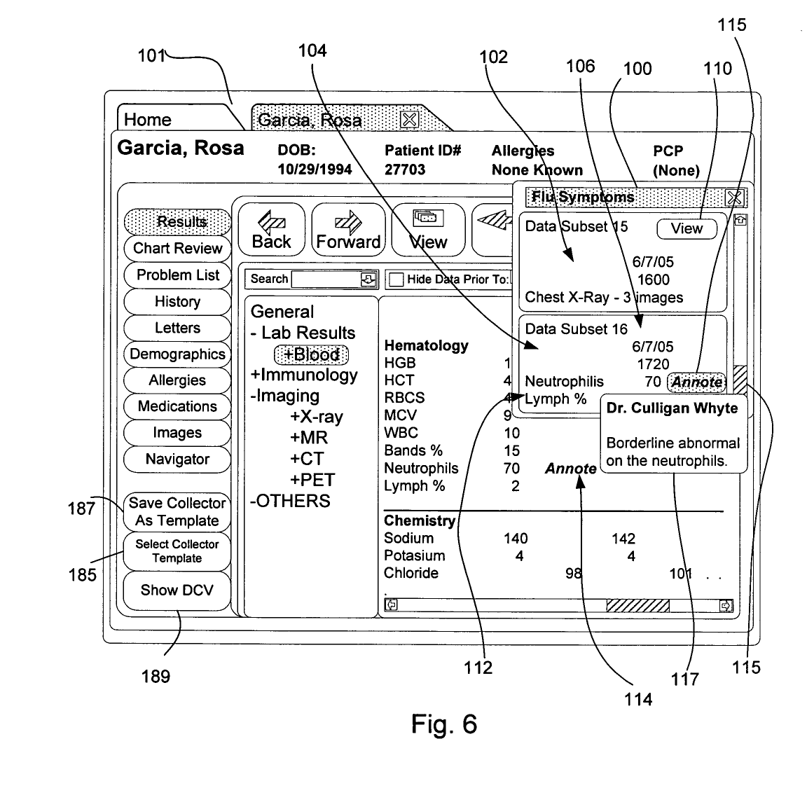

Referring now to FIG. 6, FIG. 6 illustrates another screen shot 101. Once a comment has been stored with specific data from a patient chart, in at least some embodiments, server 12 indicates that the data has been marked and annotated within the patient's chart each time that information is observed in the chart. To this end, where a comment has been correlated with DCV data, an “Annote” label 114 is provided adjacent the related data each time the data is viewed within the patient's chart. Referring also to FIG. 2, when data has simply been copied to a DCV but no comment has been associated therewith, a “Mark” label is provided adjacent the copied data each time the data is viewed in the patient's chart to indicate that the data has already been added to the DCV. In FIG. 2, two “Mark” labels are illustrated, one labeled with numeral 124. In some cases comments may just be shown in a DCV instead of requiring an action to view. In addition, in some cases the interface may be programmed to support a “hover over” feature whereby, when a mouse or otherwise controlled cursor/pointing arrow (e.g., see 60 in FIG. 5) is placed over information on a display screen, information related thereto is shown in a small window that opens proximate the cursor. For instance, when a cursor is placed on top of an “Annote” indication, a small window including the associated annotation or remark may be opened adjacent the cursor for viewing.

Referring still to FIGS. 1 and 6, in at least some embodiments, while reviewing the data in a patient's chart, a clinician may want to be able to examine the data already copied to a DCV. To view the contents of a DCV, the SHOW DATA COLLECTOR icon 189 is selectable. When icon 189 is selected, a floating data collector window 100 is opened which includes a list of all of the data that has previously been added to the DCV. In the illustrated example, separate fields are provided for each separate data subset that has been added to the collector. For example, a field 102 corresponds to a data subset 15 while a field 104 corresponds to another data subset 16. In the present example, it is assumed there are 14 other data subsets in the data DCV. To scroll among the data subset fields within DCV 100, a scrolling bar 105 is provided.

Referring still to FIG. 6, field 104 corresponds to the previous hematology data selection and annotating activity described above and includes sufficient information to quickly identify the specific data subset. For example, field 104 includes a date and time and general hematology data 112. In addition, field 104 includes an “Annote” label 116 indicating that a clinician comment is associated with the data corresponding to field 104.

In at least some embodiments it is contemplated that window 100 may remain open and floating as a clinician moves among other software programs so that data can be collected from various sources and can be copied to or referenced in the DCV from various sources. For instance, in at least some cases, it is contemplated that window 100 may remain open when the chart software is closed and when other software such as Microsoft Word, a web based Internet browser or special imaging software is opened so that information/data from a Word document links or links to browser addresses or images from the special imaging software can be added to the DCV for subsequent use. Thus, in at least some applications it is contemplated that the DCV program may run completely independently of other data processing software.

Referring still to FIG. 6, in some cases, such as, for example, in the case of medical images that are associated with data fields within DCV 100, a clinician may want to be able to quickly examine the image associated with a field. To this end, in at least the illustrated embodiment, a screen selectable VIEW icon 110 may be provided within a field (e.g., 102) associated with an image. Here, when VIEW icon 110 is selected, it is contemplated that image associated with the corresponding field 102 would be displayed for the clinician view.

In another embodiment the image may simply be displayed in box 102 if selected or a thumbnail icon representing the image may be provided in window 100. In other cases the image may be viewable within a sub-window that opens when a hover over activity is performed. In some cases buttons within window 100 may be provided to jump to related activities. For instance, if viewing a lab result within DCV window 100, one button may take you directly to a lab results view. Another DCV window button may take you to the original application (e.g., full patient's chart, an imaging application, etc.) where the data was obtained initially when the DCV was populated.

Referring once again to FIG. 1, after a clinician has completed examining a patient's data chart and populating a DCV with subsets of chart information in a manner akin to that described above, the clinician may use interface 22 to generate a CRV or complete documentation activities related to the patient's condition, a diagnosis or other event. When generating a CRV, in at least some cases, it is contemplated that the clinician will want to back up the clinician's diagnosis and prescription or at least will want to memorialize what the clinician was thinking when generating the CRV (i.e., to memorialize the decision making process). To this end, the data stored in the DCV will often be particularly useful and the clinician may want to include at least a subset of the DCV data in the final report or CRV.

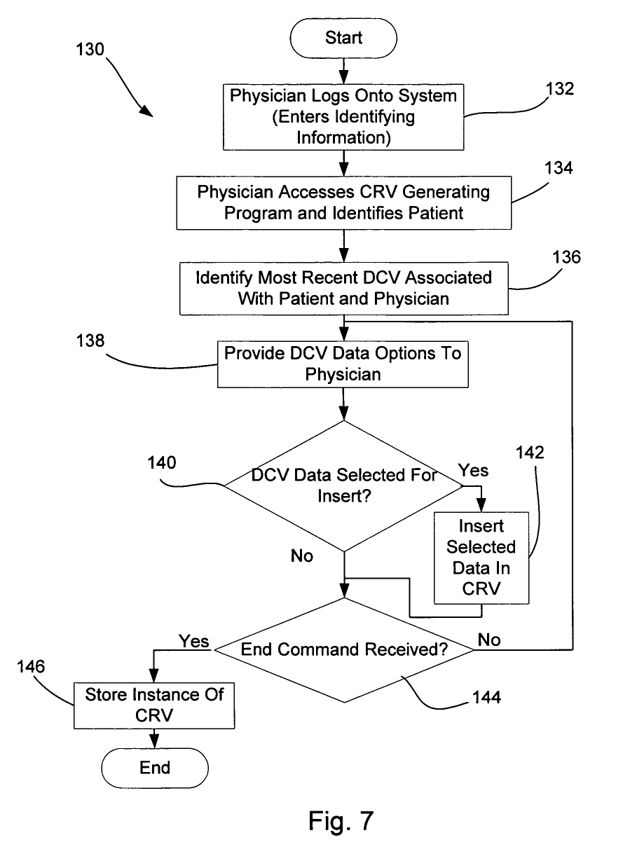

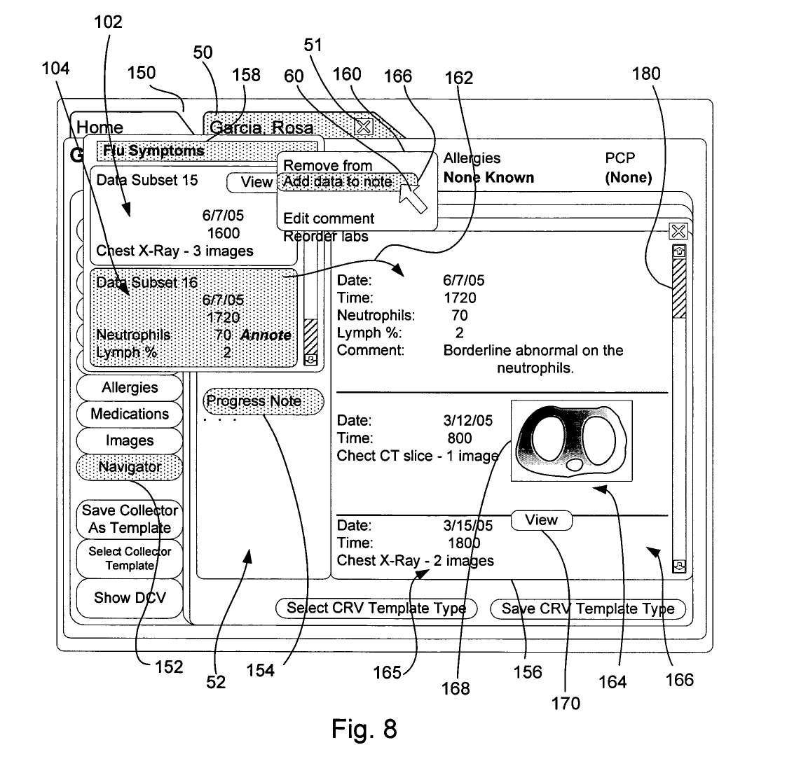

Referring now to FIG. 7, an exemplary method 130 for using information previously stored in a DCV to generate a CRV or documentation is illustrated. Referring also to FIG. 1, at block 132, a clinician logs onto system 10 by entering his clinician specific identifying information. At block 134, the clinician accesses a report generating program and enters information via interface 20 identifying the patient for which the CRV is to be generated. In this regard, see FIG. 8 where a screen shot 150 is illustrated that corresponds to Ms. Garcia. In FIG. 8, a NAVIGATOR icon is highlighted (see 152) to indicate that the NAVIGATOR icon has been selected. When the NAVIGATOR icon is selected, a different subset of hyperlink text entries is provided in directory field 52, including, among others, a “Progress Note” entry which is shown as highlighted (see 154) to indicate that the entry has been selected. When the progress note entry is selected, a progress note field 166 is provided adjacent thereto in which a clinician is free to enter text or to import data from a DCV. Hereinafter, the phrase “Progress Note” will be used to refer to a CRV document, or the like, generated by a clinician to indicate that status of a patient.

Referring still to FIGS. 1 and 7, at block 136, server 12 identifies the most recent data collector associated with the identified patient and the clinician logged onto interface 20. At block 138, server 12 provides DCV data options to the clinician. In this regard, referring again to FIG. 8, server 12 may provide a DCV window 158 that is similar to window 100 shown in FIG. 6. To this end, exemplary DCV window 158 includes a separate field for each data subset that was added to the DCV. Consistent with the example shown in FIG. 6, DCV window 158 includes illustrated fields 102 and 104 corresponding to two different DCV data subsets. In the example it is assumed that other DCV fields may be accessed by using DCV scroll bar 115.

Referring still to FIGS. 1, 7 and 8, at block 140, server 12 monitors interface 20 to identify whether or not a clinician indicates that one of the data subsets from DCV window 158 should be inserted into the progress note in field 166. Here, it is assumed that, during text entry into field 166, a clinician will be able to place a cursor anywhere within field 166 and then perform a selection process to select one or more of the data subsets from within DCV window 158 for inclusion in field 166 at the location specified by the cursor. For example, in at least one embodiment, a clinician may guide pointer icon 60 to a location anywhere within one of the fields in window 158 and perform a selection activity to select the data in the field. In some embodiments, this activity will immediately copy the data from the DCV window 158 into the note in field 156 at the location of the cursor. In other embodiments, selection of one of the fields (e.g., 102 or 104) in window 158 will cause an action menu window 160 to open up adjacent to DCV window 158 where the menu window 160 includes a list of activities that may be selected. In the illustrated example, menu window 160 includes screen selectable hyperlink text entries, including “Remove From Collector,” “Add Data To Note,” “Edit Comment” and “Reorder Labs.” When the “Remove From Collector” entry is selected, the data in the selected field (e.g., 104 in FIG. 8) is removed (e.g., deleted) from the DCV window 158. When the “Edit Comment” entry is selected, a window similar to window 88 in FIG. 5 may be opened adjacent DCV window 158 enabling the clinician to edit the comment associated with the data. When the “Reorder Labs” entry is selected, facility scheduling software may be opened in another window (not illustrated) enabling the clinician to schedule new lab tests for the specific patient. To add the data in a selected field (e.g., 104) to the note in field 166, the “Add Data To Note” entry is selected. Other methods of moving DCV data to a note are contemplated such as dragging and dropping activity, copying and pasting, etc., and the invention here should not, in its broadest sense, be limited by the method of moving data.

Referring still to FIG. 7, when the clinician has not selected any data from the DCV window 158 to be added to the note in field 166, control passes from block 140 to block 144 where server 12 monitors to determine whether or not the clinician has completed the progress note. Here, referring again to FIG. 8, note completion may be indicated by selection of the closing icon 51 associated with Tab 50. If data has been selected for insertion in a note at block 140, control passes to block 142 where the selected data is inserted into the note. In FIG. 8, exemplary data insertion is signified by arrow 162.

Referring still to FIG. 8, in at least some embodiments, when data is copied or moved from a DCV window 158 into progress note field 166 or when a data reference is copied or moved from a DCV to a note field 166, the data may be expanded. For example, when the data in field 104 is copied into field 166 as indicated by arrow 162, the comment associated with the data in field 104 is expanded in the note field 166. Similarly, when data 164 is copied into progress note field 166 where the copy data corresponds to a chest CT slice image, in at least some embodiments, the image may be presented within field 166 for immediate viewing. In other cases, screen selectable VIEW icons (e.g., see 170 in FIG. 8) may be provided with other image identifying information when data is copied to note field 166. In this case, icon 170 may be selectable to view images associated therewith.

Referring still to FIGS. 1 and 7, after block 142, control passes to block 144. At block 144, while the clinician is still creating the progress note, control passes back up to block 138 and the process corresponding to loop 138, 140, 142 and 144 continues. Once the clinician has indicated that the note or CRV generating process is complete, control passes from block 144 to block 146 where the progress note is stored for subsequent use.

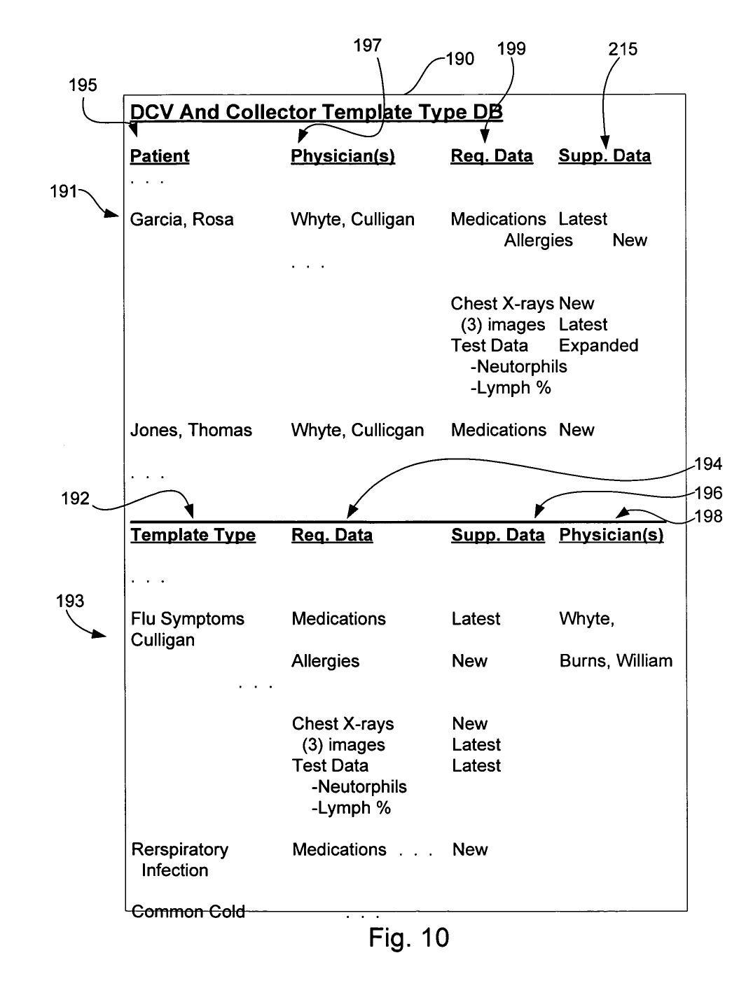

Referring now to FIG. 10, FIG. 10 illustrates a DCV and DCV template type database 190 that includes a collector section 191 and a template type section 193. DCV section 191 is where specific instances of DCVs are stored and includes a patient column 195, a clinician(s) column 197, a Data column 199 and a Supplemental Data column 215. Patient column 195 lists the patient associated with a specific DCV and clinician(s) column 197 identifies the clinician that generated an associated DCV. Data column 199 includes the data that was copied to the DCV. Column 215 indicates if the data listed in column 199 is to be supplemented with latest or new data of the same type when the DCV is provided. Thus, entries in column 215 include “Latest”, “New”, “Extended”, etc., which are consistent with the options shown in window 72 (see again FIG. 4).

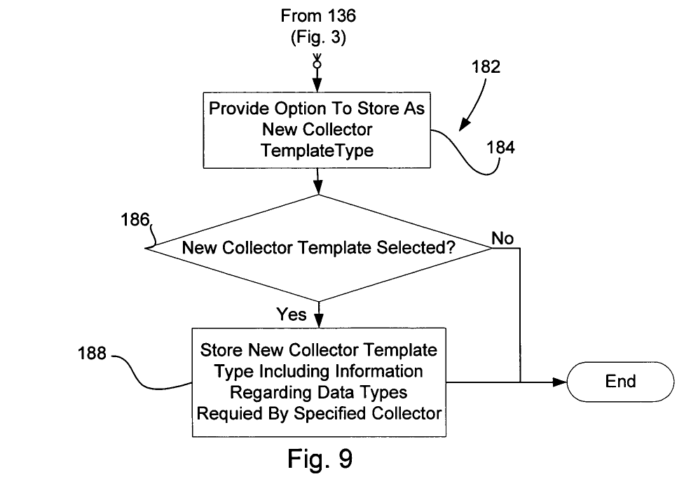

It has been recognized that, in many cases, when a clinician sees patients that have similar problems or similar conditions, the clinician will want to pay particular attention to similar subsets of patient chart data. Here, in at least some embodiments, the DCV program will enable a clinician to store DCV type templates during or after the process of copying data to a DCV for subsequent use where the template specifies data types copied to the DCV. To this end, a sub-method 182 that may be added on to the method 24 of FIG. 3 is illustrated in FIG. 9. In FIG. 3, after an instance of a DCV has been stored at block 36, control may pass to block 184 in FIG. 9. Referring also to FIG. 1, at block 184, server 12 provides an option to store a template corresponding to the DCV stored at block 36. Referring also to FIG. 2, to facilitate storage of a new template, screen shot 40 includes SAVE COLLECTOR AS TEMPLATE icon 187. When icon 187 is selected, referring also to FIG. 5, a template labeling window 201 is opened that includes instructions 203 instructing the clinician to enter a label for the new DCV template, a field 209 for entering a template label, an OK icon 205 and a CANCEL icon 207. After a template label has been entered in field 209, OK icon 205 is selectable to provide the label to server 12. To cancel storage of the new template type, CANCEL icon 207 is selectable. In FIG. 5, the label provided for the template is “Flu Symptoms”.

Referring still to FIGS. 1 and 9, if the clinician indicates that a new DCV template should be stored, control passes to block 188 where server 12 stores the new DCV template type including information regarding data types required by the DCV stored at block 36 in FIG. 3. At block 186, if the clinician does not indicate that a new DCV template type should be stored, the process ends.

Referring again to FIG. 10, database section 193 includes a template type column 192, a required data column 194, a supplemental data column 196 and a clinician(s) column 198. Type column 192, as the label implies, indicates a specific template type. In the illustrated example, the template types are identified by the labels provided by clinicians that created each template. Thus, the “Flu Symptoms” label that was entered via field 209 in FIG. 5 is shown in column 192 along with other template type labels.

Referring still to FIG. 10, required data column 194, as the label implies, indicates different types of data that are required to populate or instantiate a DCV instance associated with one of the template types in column 192. For example, for the “Flu Symptoms” template type in column 192, required data types in column 194 include medications, allergies, chest X-rays and various types of test data. Supplemental data column 196 indicates if the required data in column 194 is to be supplemented with latest or new data when a DCV is viewed. Physician(s) column 198 indicates specific clinicians that routinely use each template type in column 192. For example, for the template type labeled “Flu Symptoms” in column 192, Dr. Whyte and Dr. Burns each routinely use that template type. When a new template type is specified and labeled, template type specific data is added to database 190 for subsequent use.

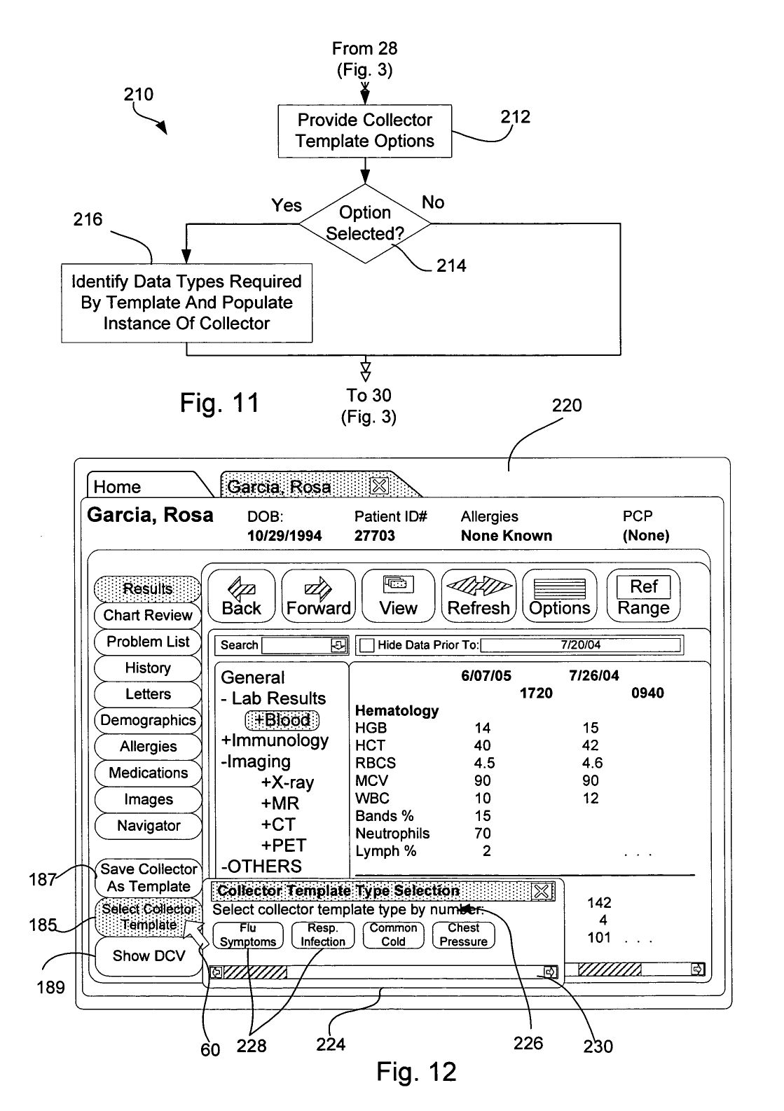

After at least one DCV template type has been specified and stored in database 190 (see again FIG. 10), the next time a clinician uses interface 20 to examine a patient's chart data, the clinician may choose one of the stored template types in an initial effort to gather a subset of chart data that is of particular interest to the clinician. To this end, referring to FIG. 11, a sub-method 210 that may be added to the method of FIG. 3 is illustrated whereby a clinician can select a DCV template type in an initial effort to gather interesting information. Referring to FIGS. 1, 3 and 11, after block 28, control may pass to block 212 where server 12 provides collector template options to the clinician.

Referring also to FIG. 12, a screen shot 220 is shown where the SELECT COLLECTOR TEMPLATE icon 185 is shown as highlighted to indicate that the icon has been selected via pointer icon 60. After icon 185 has been selected, in at least some embodiments, a DCV template type selection window 224 is opened which includes instructions instructing the clinician to select a DCV template type and screen selectable icons, one for each template type routinely used by the clinician logged onto interface 20. A scrolling bar 230 is provided along the lower edge of window 224 for scrolling the different subsets of the template type icons where all of the icons do not fit in window 224.

Referring again to FIGS. 1 and 11, at block 214, if the clinician does not select a DCV template, control passes back to block 30 in FIG. 3. At block 214, if a clinician does select a DCV template, control passes to block 216 where server 12 identifies data types required to instantiate or populate the DCV template, obtains the required data from the patient chart, and populates an instance of the DCV with the data obtained. After block 216, control passes to block 30 in FIG. 3 where the process described above with respect to FIG. 3 continues.

Referring again to FIG. 10, when a clinician accesses a previously created DCV that requires supplemental data (e.g., “Latest” or “New” data in column 215), the DCV presents the supplemental data where appropriate. To this end referring to FIG. 14, a DCV window 100′ is illustrated that includes fields 102 and 104′ where field 104′ includes the data originally selected to be added to the collector via FIG. 4 as well as the latest similar data generated on Jun. 21, 2005 during an 8:00 a.m. appointment. The latest data is shown at 268 and the originally selected data is shown at 266.

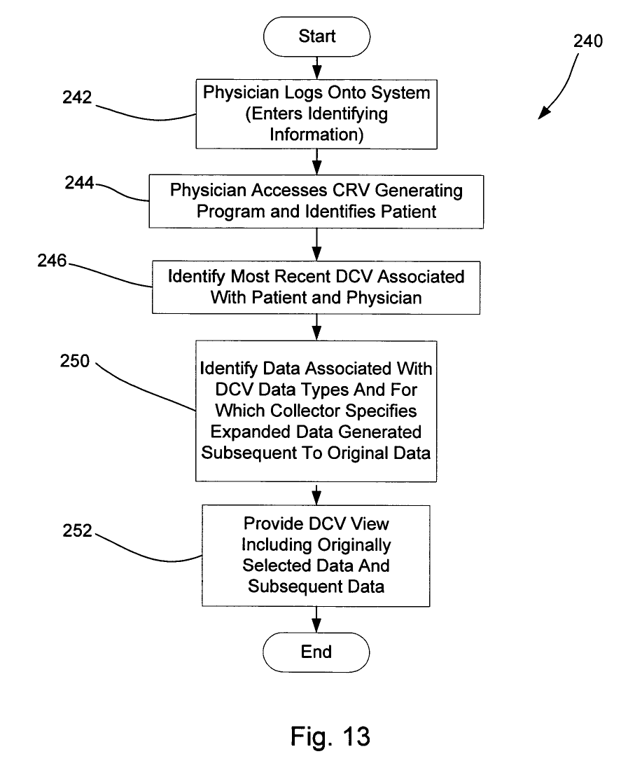

Referring now to FIG. 13, an exemplary method 240 for providing a DCV that includes data in the expanded format is illustrated. Referring also to FIG. 1, at block 242, a clinician logs onto system 10 by entering clinician specific identifying information. At block 244, the clinician accesses a report or CRV generating program via interface 20 and identifies a specific patient for which a report, CRV or progress note is to be generated. Again, here, it will be assumed that the accessing clinician intends to generate a CRV for Ms. Garcia. At block 246, server 12 identifies the most recent DCV associated with Ms. Garcia and the accessing clinician. At block 250, server 12 identifies all data associated with DCV data types including the originally selected data and subsequent data of the same type. At block 252, server 12 provides a DCV via display 21 including the originally selected data and the subsequent data. Exemplary DCV window 100′ is shown in FIG. 14, which includes originally selected data at 266 and subsequent data of the same type at 268.

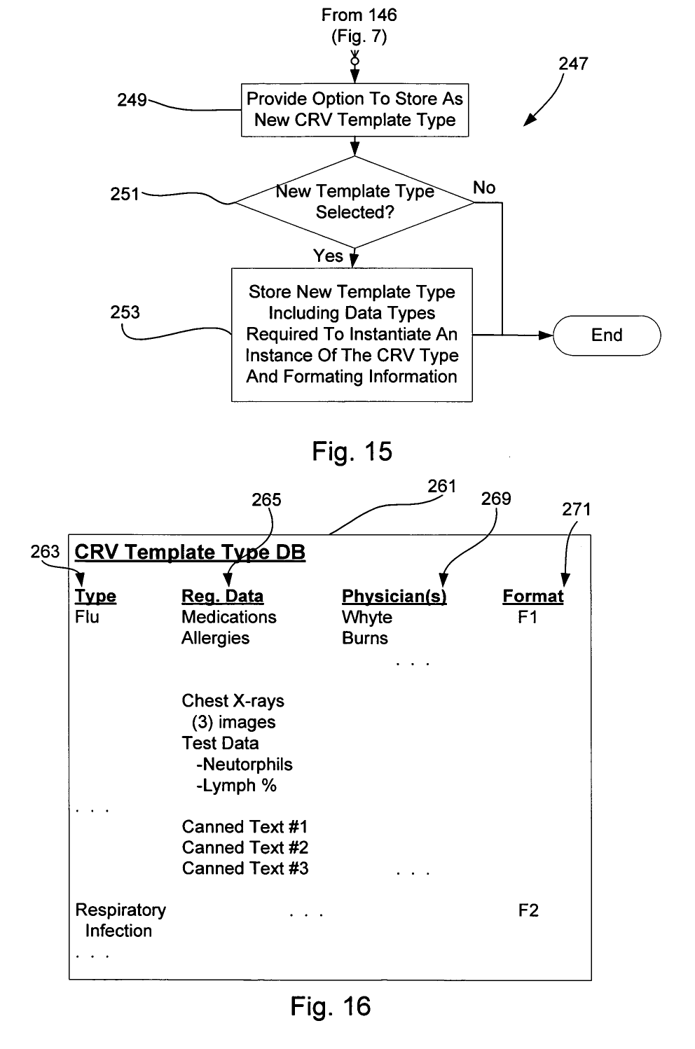

In at least some cases, it is contemplated that the progress notes that are generated by clinicians for patients having similar health and medical characteristics will be similar and, therefore, in at least some cases, it may be helpful if clinicians can store CRV templates that can be used to begin constructing a progress note. To this end, an exemplary sub-method 247 that may be included with method 130 of FIG. 7 is illustrated in FIG. 15. Referring to FIGS. 1, 7 and 15, after an instance of a CRV is stored at block 146, control may pass from block 146 in FIG. 7 to block 249 in FIG. 15. At block 249, server 12 provides an option to a clinician to store a new CRV template type that is consistent with the report instance that was stored at block 146. Referring also to FIG. 14, screen shot 260 includes a SAVE REPORT TEMPLATE TYPE icon 269 that can be selected to indicate that a new CRV template type should be stored. At block 251, when a clinician does not indicate that a new CRV template type should be stored, the process ends. If, however, at block 251, a clinician indicates that a new template type should be stored, control passes to block 253. At block 253, server 12 stores the new CRV template type including data types required to instantiate an instance of a CRV of a specific type and associated formatting information. After block 253, the process is completed.

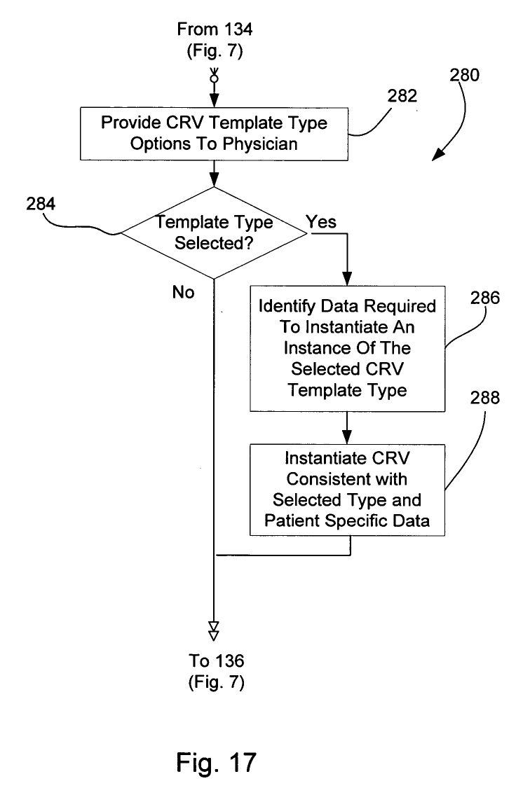

Referring now to FIG. 16, an exemplary CRV template type database 261 is illustrated which includes a CRV template type column 263, a required data type column 265, a clinician(s) column 269 and a format column 271. Template type column 263 lists each of the separate stored report template types. In FIG. 16, the template types are identified by distinguishing labels, two exemplary labels being “Flu” and “Respiratory Infection”. Column 265 includes data types that are required for instantiating an instance of each template type in column 263. In addition to indicating data types to be gleaned from a patient's chart, column 265 also lists precanned text (e.g., “Canned Text #1”, “Canned Text #2”, etc.) that may be included in a progress note. “Precanned text” includes text that is, as the label implies, input by a system user prior to use of the system which is inserted into a view at a specific location. In this regard, precanned text generally is akin to pre-existing text in a form prior to fields in the form being filled in and the information to be filled in is akin to the information gleaned from the patient chart. For instance, the precanned text may include comments that the clinician routinely makes in the case of conditions related to a specific template type (e.g., a flu). Physician(s) column 269 lists clinicians for each of the template types in column 263 that routinely use the specific template type in column 263. Format column 271 includes formatting information used to format the data and canned text in column 256. Formatting may indicate location in which data and text should be inserted in a note, text font, text size, etc.

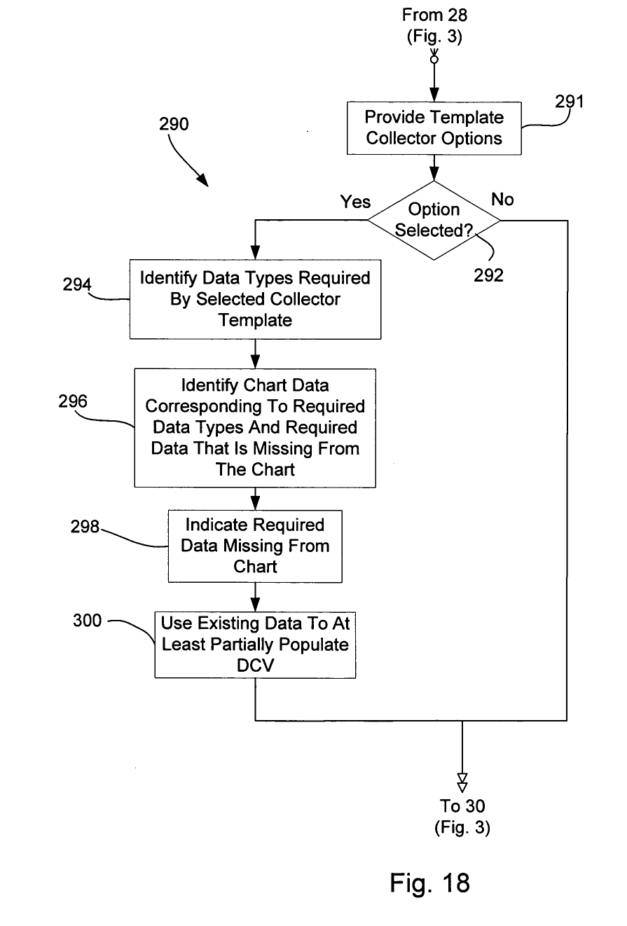

Referring now to FIG. 17, a sub-method that may be added to the method of FIG. 7 for using a previously stored CRV template is shown. Referring also to FIGS. 1 and 7, after block 134, control may pass from block 134 in FIG. 7 to block 282 in FIG. 17. At block 282, server 12 provides CRV template type options to the clinician. In this regard, referring also to FIG. 14, a SELECT REPORT TEMPLATE TYPE icon 271 is provided near the lower edge of screen shot 260. When icon 271 is selected, in at least some embodiments, it is contemplated that a CRV template type selection window akin to window 224 in FIG. 12 may be provided to allow the clinician to select from any of the CRV types stored in the CRV template type database 261. If no CRV type is selected at block 284, control passes back to block 136 in FIG. 7. Referring still to FIG. 17, if a CRV template type is selected at block 284, control passes to block 286 where server 12 identifies the data required to instantiate a CRV of the selected template type. At block 288, server 12 instantiates an instance of the CRV consistent with the selected template type and the patient specific data. After block 288, control passes to block 136 in FIG. 7 where the process in FIG. 7 continues.

Where a pre-defined and pre-stored DCV template or CRV template is used by a clinician, in at least some cases, it is contemplated that at least a subset of the information required to instantiate an instance of the DCV or an instance of a CRV will not be included in a patient's chart. For instance, consistent with the example above, where the specific DCV requires hematology data corresponding to a specific patient, the hematology data may not currently exist because hematology tests have not been previously performed. In this case, and in at least some embodiments, when a DCV is instantiated, for required data that is missing in a chart, the DCV may simply indicate that the data is not currently available. In the alternative, where a DCV requires data that is missing in a chart, other ways to indicate the missing data are contemplated, such as, for instance, providing a specific missing data window to a clinician indicating which data is required by a DCV but currently unavailable. In other cases, it is contemplated that a DCV may be used by server 12 to schedule medical tests and procedures prior to a visit to a clinician or may be used to provide notice to the clinician of missing data so that data required by a DCV that is missing in a chart can be provided.

Referring now to FIG. 18, a submethod 290 that may be substituted for a portion of the method 24 illustrated in FIG. 3 is shown. Referring also to FIGS. 1 and 3, after block 28, control may pass to block 291 in FIG. 18. At block 291, a server 12 provides DCV template options (see again FIG. 12 and specifically window 224 in this regard). Where no option is selected at block 291, control passes back to block 30 in FIG. 3. Where a DCV template option is selected at block 292, control passes to block 294.

At block 294, server 12 identifies data types required to instantiate an instance of a DCV corresponding to the selected template type. At block 296, server 12 identifies data in the patient's chart corresponding to required data types and also identifies required data that is missing from the patient's chart. At block 298, processor 12 indicates required data missing from the chart in some fashion. Here, again, the indication may take the form of a notice presented via a window opened on display 21. Other forms of providing notice of missing data are contemplated such as giving notice to a nurse, lab technician, etc. At block 300, processor 12 uses the existing data to at least partially populate or instantiate a DCV after which control again passes to block 30 in FIG. 3.

Although not illustrated, a method similar to the method of FIG. 18 is contemplated when a CRV template is used and data required in the CRV template is missing from a patient's chart.

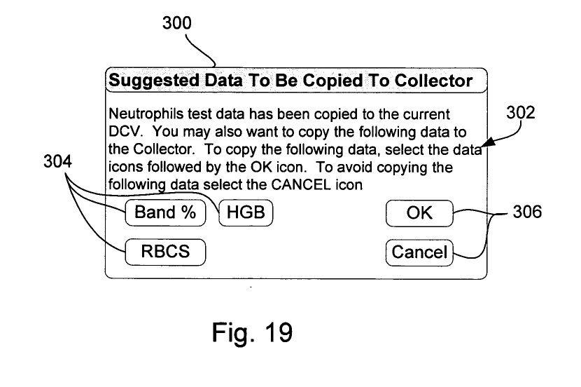

In addition, in at least some embodiments it is contemplated that, in some cases when a clinician selects specific patient chart data to be copied to or referenced in a DCV, the DCV software may cause server 12 to identify other chart data related to the copied data that the clinician will likely want to copy or reference in to the collector and may either automatically perform the additional copying activity or referencing activity or may present an option to the clinician to perform the additional copying or referencing. For instance, it may be that most of the time when Neutrophils data is of interest, Band %, HGB and RBCS hematology data will also be of interest. Here, when a clinician selects Neutrophils data to be copied to a DCV, in some cases, the other data of interest may also be automatically copied or the option to copy or reference may be presented to the clinician by opening a window via display 21 (see FIG. 1). In this regard, see FIG. 19 that shows an exemplary window 300 that may be opened to suggest copying of the other related information to the DCV. Window 300 includes instruments 302 for copying the other information as well as on screen selectable icons (e.g., 304, 306, etc.) for performing copying activity. Although not illustrated, is some cases it is contemplated that the notice would be more descriptive and may even provide a preview of the data to be copied or referenced so that the clinician's copying or referencing decision is more informed.

In the systems described above, DCV and CRV templates are stored/storable and are selectable via icons 187, 185 (see FIG. 2) and 271 and 269 (see FIG. 14) to expedite data collection processes as well as report generating processes. In addition to storing specific user defined or specified DCVs and CRVs for subsequent use, in at least some embodiments it is contemplated that the system server 12 (see again FIG. 1) may be programmed to track collector and report use trends and to correlate those trends with specific sets of circumstances that are reflected in the patient charts database and/or that include circumstances related to the way in which the system is used. Here, when a specific set of circumstances occurs, in some cases server 12 may simply select a set of pre-existing likely DCVs and/or CRVs that a clinician may want to use and provide the set as options. In other cases server 12 may be programmed to automatically select a DCV and/or a CRV for use which is consistent with the circumstances set that occurs.

For example, assume that when a specific clinician encounters a patient that has symptoms indicative of a flu virus the clinician routinely collects 15 different types of information from an existing chart associated with the patient. Here, in a simple example, server 12 may be programmed to automatically recognize the “trend” and that the trend is associated with the specific set of circumstances including (1), that the specific clinician is accessing a patient chart and (2), that a nurses pre-assessment comments indicate a possible flu diagnosis. In this case, the server 12 automatically stores a DCV template type correlating the specific clinician and the possible flu diagnosis pre-assessment circumstantial subset with the fifteen different types of information routinely accessed by the clinician as a template type (see the template type database in FIG. 10).

After the template type is recognized and stored, the next time the clinician accesses a patient chart where a possible flu diagnosis has been pre-assessed, in some embodiments the stored DCV template may be presented as an option while in other cases the stored DCV template may be automatically accessed and an instance thereof may be instantiated by obtaining the fifteen required data items from the patient's chart and populating the DCV. Here, as in the example above, if some of the fifteen data types required to instantiate the DCV instance are not available in the patient's chart, the system may indicate which data is missing, may provide tools to access the required data or tools to schedule activities (e.g., appointments) for gathering the required data or may simply leave fields in the DCV blank where appropriate.

The above simplified example is only exemplary and other far more complex examples are contemplated. For instance, in addition to or instead of recognizing specific clinicians and preassessment diagnosis as circumstances in a set to be correlated with a trend, many other circumstances and subsets thereof are contemplated. For example, other contemplated circumstances include patient characteristics such as age, weight and gender. For instance, if a specific male patient is over sixty years old and is over 250 pounds, data related to heart conditions may routinely be added to DCV's at a specific facility. Here, the circumstance set recognized by the system may include facility identity, male gender, age over sixty years and weight over 250 pounds and the required template data may include ten different health characteristics related to heart disease.

As another example, a specific clinician may always collect ten general health characteristics for each patient into a DCV irrespective of symptoms. In this case, the circumstance set recognized by the system may include clinician identity and the required template data would include the ten general health characteristics that the clinician always collects.

Other circumstances that server 12 may automatically recognize as part of a circumstantial set include but are not limited to departments of a facility to which specific clinicians belong, facilities that clinicians are associated or affiliated with, the locations of I/O devices/terminals like terminals 18, 20, etc., other patient characteristics including race, habits (e.g., smoker, alcohol drinker, fitness fanatic, etc.), previous symptoms, previous diagnosis, previous procedures, scheduled procedures, family medical history, allergies, patient home address, previous medication consumption, current medication consumption, etc., clinician specialties, disease/problem being treated, patient treatment plan, treatment team, etc. Thus, any one or a subset of the characteristics above may comprise circumstantial characteristics that cause server 12 to automatically identify and store DCV templates and then to automatically either suggest or use specific DCVs when the set of circumstance occurs again with a different patient.

Recognized trends need not be clinician specific and instead could be related to specialties or departments. For instance, where six specialists of the same type work at a single facility, data accessing trends for all six of the specialists could be monitored for and used to generate new DCV types. For instance, where all of the six specialists routinely access twelve specific types of information in patients charts and four of the specialists routinely access another three types of information in charts, the overall trend to access all fifteen information types may be recognized and used to generate a new DCV template type.

In at least some cases where trends are based on group (e.g., specialists, departments, etc.) activity as opposed to individual activities, data types added to a DCV type that are based on access by less than all of the members of a group may be earmarked or visually distinguished in some fashion and information that identifies members of the group that routinely access the information may be associated therewith. For instance, a data type added to a DCV because four of six specialists routinely access the information may cause instances of the data placed in a DCV instance to be presented in blue text as opposed to black where, when a mouse cursor is positioned over the blue text (e.g., a hovering activity), a small information window opens up adjacent the cursor which provides the names of clinicians that routinely access the information type. At the very least, this feature could spur specialists that were not routinely accessing the associated information type to ask the other specialists why they think the associated information is significant.

Where information windows can be associated with information types in a DCV, in at least some embodiments it is contemplated that clinicians may be able to attach notes or comments to specific DCV template information types to indicate the importance of considering the specific data type. Tools for adding notes to template information types may be akin to the tools in window 160 described above with respect to FIG. 8.

When a trend occurs and is recognized by server 12 is a matter of designer choice. For example, is some cases after a pattern of a specific circumstantial set and collected data has been recognized to have occurred three consecutive times, server 12 may form a DCV template for storage and subsequent use to be automatically either used or suggested the next time the circumstantial set occurs. In other cases two or more than three consecutive occurrences may be required or perhaps four of six consecutive occurrences may be the threshold for storing new template types.

The threshold for recognizing trends may be completely customizable/configurable by a facility or a group of related facilities and may be different for individuals, departments, specialists and for different sets of circumstances.

In some cases server 12 may be programmed to use multiple DCV templates to assemble a DCV for use by a clinician where some information in the resulting DCV is obtained using the first template and other DCV information is obtained using the second template. For instance, in the examples above where a first template is used when a male patient is more than 60 years old and weighs more than 260 pounds and a second template is used when a specific clinician uses the chart system irrespective of symptoms/circumstances, when the specific clinician accesses a patient chart associated with a male patient that is older than sixty years old and that weighs more than 250 pounds, server 12 may recognize both the first and second templates as applicable to the set of circumstances. In this case, server 12 may be programmed to combine the first and second DCV templates to form a single DCV and to then instantiate the single DCV automatically.

In other cases the system may store a set of hierarchical rules for determining which one of several DCV's should be used where more than one DCV may be applicable given circumstance sets.

While the above example involves combining two templates, in at least some embodiments server 12 may be programmed to combine more than two templates where appropriate to generate an instance of a DCV. For instance, where circumstances that occur are consistent with four different DCV templates, server 12 may use all four DCV templates to generate a single DCV. In at least some embodiments a clinician may be able to manually identify two or more DCV's to be combined to form a single DCV instance. In cases where two or more templates are used to generate a DCV, server 12 may be programmed to recognize duplicative data in the template and to only include one instance of the duplicative data in the resulting DCV.

While the example above relates to automatically identifying DCV trends and generating DCV templates for subsequent suggestion and/or automatic use, it should be appreciated that the discussion is also applicable to CRV templates recognition, storage and subsequent suggestion and use.

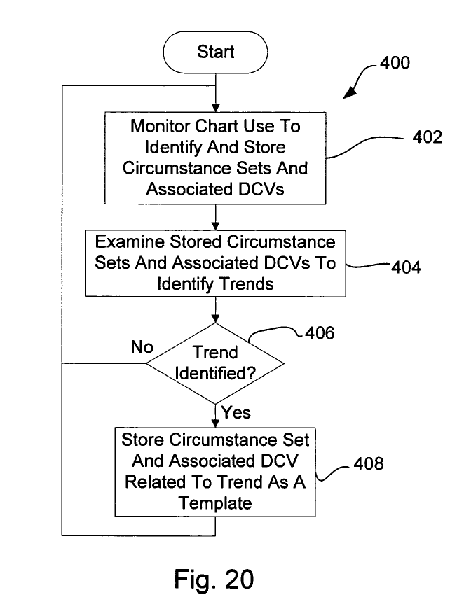

Referring now to FIG. 20, an exemplary method 400 for automatically creating DCV templates is illustrated. Referring also to FIG. 1, at block 402, as a clinician uses one of the I/O terminals (e.g., 20) to access a patient chart and place information in a DCV, server 12 monitors use and circumstances to identify and store circumstance sets and associated DCVs. At block 404, after several circumstance sets and associated DCVs have been stored, server 12 runs a software routine to identify any trends (e.g., three consecutive identical circumstance set-DCV associations). At decision block 406, when a trend is not identified, control passes back up to block 402 where monitoring continues. When a trend is identified at block 406, control passes to block 408 where the current circumstance set and associated DCV information that is consistent with the trend is stored as a new template in the template database.

In addition to identifying DCV trends, in at least some embodiments, server 12 may be programmed to simply identify chart data/information that is accessed by a clinician, members of a specialty, department members, etc., and to automatically specify DCV templates when data access trends are recognized. Thus, here, instead of relying on manual addition of information types to DCV instances for identifying trends used to generate DCV template types, the server automatically identifies data types based on system use and related circumstance sets to generate DCV template types.

Here, referring again to FIG. 20, at block 402, server 12 monitors chart use to identify circumstance sets and associated chart data that is accessed during chart use. Circumstance sets and associated accessed chart data are stored in a database (see database 14 in FIG. 1). At block 404, server 12 examines the stored circumstance sets and associated accessed data types to identify trends. At block 406, where no trend is identified, control passes back up to block 402. When a trend is identified at block 406, control passes down to block 408 where server 12 stores the circumstance set and associated data types that comprise the trend as a DCV template.

Trends may be identified on a data type by data type basis for specifying DCV templates. For instance, where three patient charts are accessed by a clinician and the clinician accesses 15 data types for one patient, 20 data types for another patient and 25 types for the third patient where the common data types include only six types, the DCV template specified would only include the six common types.

In the alternative, another rule may be that where two thirds (e.g., 66%) of the time a clinician accesses a specific data type, the type is added to a DCV template. Here, where, in addition to the six common data types above, the clinician accesses another five common data types for each of the first and second patients, another five common data types for each of the second and third patients and another two common data types for each of the first and third patients, the DCV template may include the six data types in common between all three patients as well as the other twelve data types common between at least two of the patients for a total of eighteen data types. In other cases a default may be to add all data types accessed by a clinician to a DCV template.

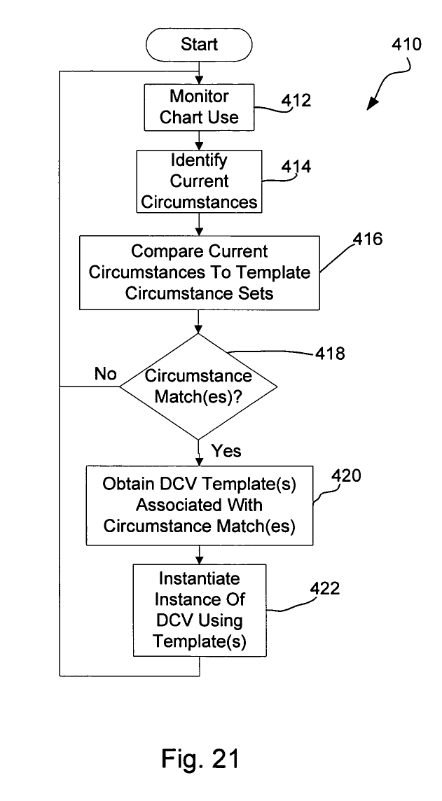

Referring to FIG. 21, a process 410 for automatically using one or more existing templates to instantiate a DCV instance when specific circumstances occur is illustrated. Referring also to FIG. 1, when a clinician first uses an I/O terminal (e.g., 20) to access a patient record, at block 412 server 12 monitors chart use. At block 414, server 12 identifies subsets of different current circumstances. At block 416 server 12 compares current circumstances to template circumstance sets and, at block 418, when no match occurs, control passes back up to block 412 where the loop continues. At block 418, where current circumstances match at least one of the stored circumstance sets or where circumstances are within some threshold (e.g., 80% of circumstances match) of a DCV template circumstance set, control passes to block 420 where server 12 obtains the DCV template associated with the matching circumstance set. At block 422 an instance of a DCV is instantiated that is consistent with the obtained template. The plural modifiers in FIG. 21 are provided to reflect the fact that multiple templates may be used some times to instantiate a single DCV where current circumstance warrant (e.g., where current circumstances match two or more stored circumstance sets).

After a set of DCV templates have been stored, in at least some embodiments it is contemplated that server 12 may be programmed to update or alter templates automatically as trends change. For instance, if a specific existing DCV template associated with a specific circumstantial set is routinely (e.g., five consecutive items) manually supplemented with five additional data items, server 12 may be programmed to automatically amend the existing DCV template to include the additional five data items. In at least some cases where a clinician adds data items to a DCV instance once or routinely, a new or updated DCV template may be generated for use only by the single clinician. In other cases a specialty or department DCV template may be altered as a function of individual activities or when new group trends (e.g., multiple clinicians in a department routinely access a specific data type or add a specific data type to a DCV instance that is not already a DCV template) are recognized. Similarly, server 12 may be programmed to recognize trends where data items in DCVs generated using existing templates are being routinely deleted so that the templates can be updated to eliminate the data items.

As information is changed in a patient chart server 12 can automatically and in real time select and instantiate different templates to suit the changing circumstantial set. For instance, where a clinician is examining a patients chart, if the clinician or some other records keeper corrects the chart so that, instead of indicating that a patient is over 40 years old, the chart indicates that the patient is 90, a template consistent with a 90 year old may be selected immediately and instantiated automatically

While the automatic DCV instantiation process is described above in the context of a template based system, in at least some embodiments DCV trends may be identified in real time by analyzing most recent system activities. For instance, for a specific clinician, server 12 may be programmed to search the most recent three DCVs created by that clinician irrespective of other circumstances and to create, in real time, a DCV instance that includes all data items common to the three most recent DCVs created. Here, each time the clinician accesses a new chart, the process of identifying common data items in the three prior consecutive DCVs would be performed anew. Over time the instantiated DCVs would change if the clinician adds and deletes data items from current DCV instances (i.e., the instantiated DCVs populated automatically and altered by the clinician).

In at least some embodiments it is contemplated that when a DCV template choice is presented to a clinician or prior to automatically instantiating a DCV instance, server 12 may be programmed to provide information to explain why specific DCV templates are suggested or why they are going to be used so that the clinician has some context in which to view the DCV activities. For instance, explanation information may include text like, “You are accessing patient X's chart, we suggest DCV YYY because ZZZ and QQQ circumstances exist (e.g., the patient is over 60 years old and weighs more than 250 pounds). Where DCV choice is provided, a separate explanation for each DCV choice may be provided. In addition, where DCV choice is provided, a tool (e.g., a separate selection box to be checked) may be provided to enable the clinician to accept more than one DCV template to be cobbled together to generate a DCV instance. In short, the rules that trigger a DCV template suggestion may be presented.

Where DCV templates are automatically selected and used, prior to instantiation of a DCV instance, a window may pop up providing an explanation of why the template is to be used. Similar information windows could be provided for each data type in a DCV instance that are accessible via a hovering type activity.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, while collector and report template storage is contemplated above where templates are stored after collectors or reports have been completely specified, in at least some embodiments, template storage may be performed prior to complete specification of a specific instance of a DCV or a progress note/CRV. In addition, after a DCV template is selected and instantiated to generate a DCV instance including data from a patient's chart, a clinician can, in at least some embodiments, add additional patient data to the DCV or remove data from the DCV in order to customize the DCV for a specific application. Similarly, progress notes initiated via a CRV template can be customized for particular applications by inserting or deleting specific data types.

Moreover, in at least some embodiments, it is contemplated that a clinician may be able to move back and forth between the CRV generating tools and the DCV tool so that additional chart data can be obtained when necessary during creation of a progress note. For instance, if, while creating a note, a clinician remembers four other data subsets that would be useful, the clinician could re-enter the chart, copy the four additional data subsets to the DCV and then return to the CRV generating tool.

In applications where DCV software remains operational as a clinician moves from viewing data associated with one patient to viewing data associated with a second patient, the software has to be programmed to recognize the switch and not commingle or allow the commingling of data from two or more patients into a single DCV.

In addition, in at least some cases the DCV program may enforce security rules to only provide DCV information in a DCV that specific clinicians have authority to access and to filter out information that a specific clinician cannot access. In this regard, for instance, while a DCV template may be specified that requires test result related to sexually transmitted disease, certain clinician's may not have authority to access/view such information. Here, while most of a DCV template may be populated for a specific clinician, other restricted data may be blocked.

Furthermore, in at least some applications the interface software may provide a clinician an option to either copy a data subset to a DCV or to render the subset accessible in some other fashion such as placing a link (e.g., a hyperlink phrase) in the DCV that, when selected, presents the subset.

In some cases chart data may require a special viewer and therefore may not be able to be added to a DCV or a CRV. In these cases the data may appear in a chart in a distinguished fashion (e.g., grayed out).

When a CRV or a DCV includes referencing links of any kind, when the CRV or DCV is printed out, the system in at least some cases, will be programmed to obtain the data referenced by the links and fill in the CRV or DCV so that meaningful documents are created.

To apprise the public of the scope of this invention, the following claims are made:

What is claimed is:

1. A method for use with a database that includes patient charts where each chart includes a plurality of subsets of patient data, the method for allowing a clinician to generate a custom report view (CRV) including at least a subset of the patient data, the method comprising the steps of:
during a collection process:
providing an interface that enables the clinician to access the patient chart data;
presenting patient chart data via the interface; and
receiving a selection from the clinician via the interface that selects at least one subset of the chart data; and
rendering the at least one subset of the data chart data accessible in a data collector view (DCV) for subsequent use.

2. The method of claim 1 further including the step of, during a CRV specifying process subsequent to the collection process, presenting the selected data to the clinician.

3. The method of claim 2 further including the step of, during the CRV specifying process, receiving an indication from the clinician that chooses at least a subset of the presented data.

4. The method of claim 3 further including the step of rendering the chosen data accessible in the CRV.

5. The method of claim 4 wherein the step of rendering the chosen data accessible in the CRV includes providing an instance of the chosen data in the CRV.

6. The method of claim 5 further including the step of, during the CRV specifying process, receiving an indication from the clinician that identifies a location within the CRV for providing the instance of the chosen data and wherein the step of providing the instance includes providing the instance at the identified CRV location.

7. The method of claim 4 wherein the step of rendering the chosen data accessible in the CRV includes providing a link within the CRV that, when selected, provides an instance of at least a portion of the associated data.

8. The method of claim 1 further including the step of receiving an indication via the interface that a template corresponding to selected data subsets should be stored and, after at least one subset of chart data is selected, storing a DCV template that identifies selected subsets of chart data for subsequent use.

9. The method of claim 8 further including the steps of, subsequent to storing the template, accessing a second patient's chart data and using the template to automatically identify subsets of data in a second patient's chart.

10. The method of claim 9 further including the step of, during a CRV specifying process, presenting the automatically identified subsets of data to the clinician.

11. The method of claim 2 further including the steps of, during the collection process, receiving indications from the clinician via the interface that select multiple subsets of the chart data.

12. The method of claim 11 further including the steps of, during the CRV specifying process, receiving formatting information indicating how at least a portion of the multiple subsets of the chart data should be configured to form a portion of a CRV and receiving an indication via the interface that a CRV template corresponding to the configured CRV should be instantiated and storing a CRV type template that identifies the CRV configuration for subsequent use.

13. The method of claim 12 further including the steps of, subsequent to storing the CRV template, accessing a second patient's chart data and using the template to automatically identify data subsets in a second patient's chart needed to instantiate a CRV instance consistent with the CRV template and using the identified data to instantiate a CRV instance consistent with the CRV template for the second patient.

14. The method of claim 1 further including the steps of, after a data subset is selected, receiving a comment via the interface that is associated with the selected data and storing the comment with the selected data for subsequent access.

15. The method of claim 2 further including the step of, after a data subset is selected, receiving an indication via the interface that the data should be supplemented in the future with subsequently generated data of the same type, the step of presenting the selected data to the clinician including presenting the supplemental data along with the selected data.

16. The method of claim 1 wherein the subsets of data include at least a subset of medical history, medical documentation, medications prescribed, medications consumed, insurance information, test/procedure results, tests/procedures performed, clinician comments, medical images, a patient image, physical characteristics, diagnosis and symptoms.

17. The method of claim 1 further including the step of, when a chart data subset is selected, identifying other data that is related to the selected chart data.

18. The method of claim 17 further including the step of indicating the other data that is related to the selected chart data.

19. The method of claim 18 wherein the step of indicating the other data that is related to the selected data includes, during a CRV specifying process subsequent to storing the selected data, presenting the other data in addition to the selected data to the clinician.

20. The method of claim 1 wherein the step of presenting patient chart data via the interface includes presenting patient chart data via a plurality of applications, the step of receiving a selection from the clinician via the interface that selects at least one subset of the chart data includes receiving at least two selections from the clinician via the interface that select at least first and second different subsets of data that are associated with at least first and second different applications and wherein the step of rendering includes rendering all of the selected data as a DCV for subsequent use.

21. The method of claim 20 further including the step of presenting the DCV via the interface as the data is stored in the DCV.

22. The method of claim 21 wherein the step of presenting the DCV via the interface includes opening a window via the interface and presenting the DCV via the opened window.

23. The method of claim 22 wherein the opened window remains open as the interface is used to access different applications.

24. The method of claim 1 wherein the step of rendering includes at least one of copying the selected data into the DCV and placing a selectable link in the DCV that, when selected, causes an instance of the selected data to be presented.

25. A method for use with a database that includes patient charts where each chart includes subsets of different types of patient data, the method for allowing a clinician to generate a custom report view (CRV) including subsets of patient data from a chart, the method comprising the steps of:
providing an interface;
receiving specifying information from the clinician via the interface that specifies a subset of chart data types to be includes in a data collector view (DCV) template; and
storing the specified subset of chart data types in a DCV template for subsequent use.

26. The method of claim 25 wherein the step of receiving specifying information includes providing a patient chart and receiving specifying information from a clinician indicating specific data in the chart to be included in a DCV.

27. The method of claim 25 further including the steps of, after storing the DCV template:
accessing data in a patient's chart;
accessing the data DCV template to identify data types required to instantiate a data DCV instance consistent with the template type;
obtaining data from the patient's chart that is required to instantiate a data DCV instance consistent with the template type; and
using the obtained data to instantiate a data DCV instance consistent with the template type.

28. A method for use with at least first and second different software programs where each program presents data subsets when operating, the method for collecting data subsets and comprising the steps of:
providing an interface;
performing the first program to provide data subsets via the interface;
receiving selections from an interface user selecting at least a first data subset provided by the first program;
rendering the first data subset accessible via a data collector view (DCV);
performing the second program to provide data subsets via the interface;
receiving selections from an interface user selecting at least a first data subset provided by the second program; and
rendering the data subset selected from the second program accessible via the data collector.

29. The method of claim 28 wherein the steps of rendering includes at least one of copying the selected data into the DCV and placing a selectable link in the DCV that, when selected, causes an instance of the selected data to be presented.

30. An apparatus for use with a database that includes patient charts where each chart includes a plurality of subsets of patient data, the system for allowing a clinician to generate a custom report view (CRV) including at least a subset of the patient data, the system comprising:
an interface that enables the clinician to access the patient chart data during a collection process, the interface including an input for receiving a selection from the clinician via the interface that selects at least one subset of the chart data; and
a processor for rendering the at least one subset of the data chart data accessible in a data collector view (DCV) for subsequent use.

31. A method for use with a database that includes patient charts where each chart includes subsets of patient data, the method for automatically identifying trends in accessed data and generating at least one template for subsequent use, the method comprising the steps of:
during a data collection process:
providing an interface that enables the clinician to access chart data for a first patient;
presenting first patient chart data via the interface;
receiving indications from the clinician via the interface that select a plurality of the subsets of the chart data;
identifying a circumstance set that exists when the plurality of subsets of chart data are selected;
identifying trends in the selected chart data and associated circumstance sets; and
when a trend is identified, storing the circumstance set along with a template that specifies the selected chart data types for subsequent use.

32. The method of claim 31 further including the steps of, subsequent to storing the template and associated selected chart data types, while a clinician accesses chart data for at least one of the first patient and a second patient, monitoring use of the interface to identify circumstance sets that occur, comparing occurring circumstance sets to the stored circumstance sets, when an occurring circumstance set is at least similar to a stored circumstance set, accessing the template associated with the stored circumstance set, accessing information required to instantiate an instance of the from the chart data accessed by the clinician and instantiating an instance of the template using the accessed information.

33. The method of claim 31 where the template type is one of a data collector view template and a custom report view template.

34. A method for use with a database that includes patient charts where each chart includes subsets of patient data, the method for automatically instantiating an instance of at least one data template when certain circumstances occur, the method comprising the steps of:
storing at least one template that specifies specific data items required to instantiate an instance that is consistent with the template;
storing a circumstance set that is associated with the stored template;
providing an interface that enables the clinician to access chart data for a first patient;
accessing the first patient chart using the interface;
identifying at least one occurring circumstance set including circumstances related to the use of the interface and the information in the first patient chart;
comparing occurring circumstance sets to the stored circumstance sets;
when an occurring circumstance set is at least similar to a stored circumstance set:
accessing the template associated with the stored circumstance set;
accessing information required to instantiate an instance of the accessed template from the chart data accessed by the clinician; and
instantiating an instance of the accessed template using the accessed information.

35. The method of claim 34 where the template type is one of a data collector view template and a custom report view template.
